(19) United States
(12) Patent Application Publication
(10) Pub. No.: US 2013/0302688 A1
(43) Pub. Date: Nov. 14, 2013

(54) LITHIUM SECONDARY BATTERY AND METHOD FOR PRODUCING SAME

(71) Applicant: Hideharu Takezawa, Nara (JP)

(72) Inventor: Hideharu Takezawa, Nara (JP)

(73) Assignee: PANASONIC CORPORATION, Osaka (JP)

(21) Appl. No.: 13/981,084

(22) PCT Filed: Jan. 13, 2012
(86) PCT No.: PCT/JP2012/000181

§ 371 Date: Jul. 22, 2013

(30) Foreign Application Priority Data
Jan. 24, 2011 (JP) 2011-012152

(51) Int. Cl. H01M 4/525; H01M 4/04

(52) U.S. Cl. CPC H01M 4/525; H01M 4/04
USPC 429/223; 429/231.1; 429/231.3; 29/623.1

(57) ABSTRACT

A lithium secondary battery according to the present invention includes a positive electrode containing a positive electrode active material capable of occluding/releasing lithium ions; a negative electrode containing a negative electrode active material capable of occluding/releasing lithium ions; a separator located between the positive electrode and the negative electrode; and an electrolyte having a lithium ion conductivity. The positive electrode active material contains a lithium nickel complex oxide substantially having an irreversible capacity; the negative electrode active material has lithium occluded thereto in advance; and in a completely discharged state of the lithium secondary battery when an environmental temperature is 25° C., an amount of lithium releasable from the negative electrode is larger than an irreversible capacity of the lithium secondary battery.

### TECHNICAL FIELD

The present invention relates to a lithium secondary battery and a method for producing the same.

### BACKGROUND ART

Lithium secondary batteries have a large capacity and a high energy density and are easy to be decreased in size and weight, and therefore are widely used as power supplies of small-sized mobile electronic devices, for example, mobile phones, personal digital assistants (PDAs), laptop personal computers, camcorders, portable game machines and the like. In the future, such small-sized mobile electronic devices are desired to have a larger number of functions and to be drivable for a longer time. When such a device is driven, the environmental temperature of the battery is relative high (30 to 60° C.) due to the heat generation in the components of the device. Therefore, the battery is desired to have a high level of performance (capacity, life) even in a more severe environment than conventional batteries.

In order to attain a further increase in the capacity of lithium secondary batteries, development of active materials is under way. As positive electrode active materials, lithium-containing transition metal oxides, for example, are used. Known lithium-containing transition metal oxides include lithium-containing complex oxides such as lithium cobalt oxide (LiCoO₂) and lithium nickel oxide (LiNiO₂) having a layer structure, lithium manganese spinel (LiMn₂O₄) having a spinel structure, and the like.

Among such lithium-containing complex oxides, lithium-containing complex oxides such as LiNiO₂ and the like have a large reversible capacity (180 to 200 mAh/g) in a voltage range that is used for LiCoO₂, and is capable of occluding/releasing a larger amount of lithium. Therefore, use of LiNiO₂ realizes a lithium secondary battery having a larger capacity while minimizing a side reaction such as decomposition of an electrolyte solution or the like. However, there is a problem that a lithium secondary battery using LiNiO₂ has a short charge/discharge cycle life due to the low stability of the crystalline structure of LiNiO₂. In addition, nickel-based lithium-containing complex oxides generally have an irreversible capacity which is substantially unusable at room temperature. Therefore, a battery using a nickel-based lithium-containing complex oxide as a positive electrode active material has a problem of losing an initial capacity as a battery.

There are various reasons why the nickel-based lithium-containing complex oxides have an irreversible capacity.

For example, main reasons why a negative electrode has an irreversible capacity are that a solid electrolyte interface (SEI) is formed at the initial charge, the oxide is reduced, and lithium occluded by charge is trapped in a crystalline structure. Many of these are irreversible reactions. Meanwhile, a main reason why a positive electrode has an irreversible capacity is considered to be increase in polarization which is caused by delay in lithium diffusion in the crystalline structure at a late stage of the discharge. Such an irreversible capacity is not a complexly irreversible capacity, and varies in accordance with the temperature or the current density. Namely, a reversible capacity can be increased to some extent by raising the temperature or decreasing the current density to decrease the reaction resistance.

There are several methods for minimizing the loss of the initial capacity of the battery to increase the cell capacity.

(1) Decrease the irreversible capacity of the positive electrode and the negative electrode (material, electrode).

(2) Performing a pre-process of having the negative electrode occlude or release Li in advance to solve the problem of irreversible capacity before the battery is assembled.

(3) Balancing the irreversible capacities of the positive electrode and the negative electrode with each other so that the irreversible capacities are cancelled.

As a method for (1), Patent Document 1, for example, proposes using a positive electrode active material having a part of Ni of LiNiO₂ substituted with another element such as cobalt (Co), aluminum (Al) or the like in order to stabilize the crystalline structure of a lithium nickel oxide. Patent Document 2 proposes a technology of decreasing the irreversible capacity of the positive electrode active material by using LiNi_{0.80}Co_{0.15}Al_{0.05}O₂ as a positive electrode active material, performing charge/discharge first at room temperature after the battery is assembled, and then repeating charge/discharge three or more times in a heated state of 45 to 60° C.

As a method for (2), Patent Document 3, for example, discloses bonding a lithium foil to a carbon material of the negative electrode (transfer method) to have the carbon material occlude lithium in advance.

A method for (3) is disclosed in, for example, Patent Document 4. It is disclosed in Patent Document 4 that in a battery including a negative electrode formed of a carbon-based material and a positive electrode formed of a nickel-based lithium-containing complex oxide material, the irreversible capacity of the negative electrode formed of the carbon-based material is made appropriate (equal to or higher than 39 mAh/g and equal to or lower than 61 mAh/g) so that the capacity loss caused by the irreversible capacity of the nickel-based lithium-containing complex oxide is cancelled and thus the decrease in the battery capacity is minimized.

### CITATION LIST

### Patent Literature

Patent Document 1: Japanese Laid-Open Patent Publication No. 8-213015
Patent Document 2: Japanese Laid-Open Patent Publication No. 2000-268874
Patent Document 3: Japanese Laid-Open Patent Publication No. 5-144472
Patent Document 4: Japanese Laid-Open Patent Publication No. 2008-226643

### SUMMARY OF INVENTION

### Technical Problem

A lithium secondary battery is usually installed inside an electric device or the like and may be used at a temperature higher than room temperature (used at, for example, 45° C.) However, with the above-described conventional technologies, it is difficult that a battery using a lithium transition metal complex oxide as a positive electrode active material has a large capacity while keeping a cycle characteristic thereof high when being used in a high temperature environment.

When the positive electrode active material proposed in Patent Document 1 is used, the irreversible capacity of the positive electrode active material is decreased and thus the charge/discharge cycle characteristic is improved. Patent Document 2 describes that since the battery capacity at 20° C. after being charged/discharged in a heated state is increased than before charged/discharged in the heated state, the polarization in a late stage of the discharge of the positive electrode active material can be reduced by the charge/discharge in the heated state. However, when the present inventor charged/discharged a battery in a heated state at 45 to 60° C. and then performed a charge/discharge test on the battery after the temperature returned to room temperature, the battery capacity was returned to the capacity before the battery was charged/discharged in the heated state. Namely, it is considered that the polarization in a late stage of the discharge of the positive electrode active material is reversible and the capacity cannot be irreversibly increased by the charge/discharge in a heated state. The battery disclosed in Patent Document 2 has a reversible capacity of 99 to 124 mAh/g and a filling density of the active material of 2.43 g/cm³. As can be seen, the energy density of the positive electrode is low.

Patent Document 3 proposes having the negative electrode occlude a prescribed amount of lithium in advance in order to allow the irreversible capacities of the positive electrode and the negative electrode to be cancelled by each other at room temperature (20° C.). However, the transfer method of bonding a lithium foil directly to a part of a surface of the carbon material conventionally as the following problem. Lithium is occluded to only the vicinity of a part of the surface of the carbon material that faces the lithium foil, and thus it is difficult to have the entire surface of the carbon material occlude lithium uniformly.

In addition, studies made by the present inventor found that with the transfer method, lithium is occluded to the vicinity of the surface of the carbon material and does not easily enter the inside of the carbon material. Therefore, it is difficult to have the carbon material occlude a large amount of lithium in advance.

Therefore, as described later in detail, even when the environmental temperature of the lithium secondary battery is changed, the battery capacity is kept approximately the same, and an increase in the capacity of the positive electrode by the environmental temperature cannot be utilized.

According to the technology disclosed in Patent Document 4, the capacity loss caused by the irreversible capacity of the positive electrode can be decreased. However, this technology makes the irreversible capacity of the negative electrode appropriate based on the irreversible capacities of the positive electrode and the negative electrode at 25° C., and does not assume that the charge/discharge behavior of the positive electrode or the negative electrode changes when the environmental temperature is changed.

As described above, none of Patent Documents 1 through 4 gives consideration to a change in the charge/discharge behavior of the positive electrode in accordance with the environmental temperature of the lithium secondary battery. In a high temperature environment, the reversible capacity of the positive electrode can be increased. Nonetheless, studies made by the present inventor found that any of the lithium secondary batteries disclosed in Patent Documents 1 through 4 cannot sufficiently enjoy such an increase in the capacity of the positive electrode.

The present invention, made in light of the above-described situation, has an object of, in a lithium secondary battery using a lithium transition metal complex oxide as a positive electrode active material, realizing a large capacity while suppressing decrease in the charge/discharge cycle characteristic.

### Solution to Problem

A lithium secondary battery according to the present invention includes a positive electrode containing a positive electrode active material capable of occluding/releasing lithium ions; a negative electrode containing a negative electrode active material capable of occluding/releasing lithium ions; a separator located between the positive electrode and the negative electrode; and an electrolyte having a lithium ion conductivity. The positive electrode active material contains a lithium nickel complex oxide substantially having an irreversible capacity; the negative electrode active material has lithium occluded thereto in advance; and in a completely discharged state of the lithium secondary battery when an environmental temperature is 25° C., an amount of lithium releasable from the negative electrode is larger than an irreversible capacity of the lithium secondary battery.

A method for producing a lithium secondary battery according to the present invention includes (A) step of preparing a positive electrode including a lithium nickel complex oxide substantially having an irreversible capacity as a positive electrode active material capable of occluding/releasing lithium ions, and a negative electrode including a negative electrode active material capable of occluding/releasing lithium ions; (B) step of having the negative electrode active material occlude lithium in advance by a vacuum vapor deposition method or an electrochemical technique; and (C) step of locating the negative electrode after lithium is occluded to the negative electrode active material in advance and the positive electrode such that the negative electrode and the positive electrode have a separate therebetween, thereby forming an electrode group. An amount of lithium to be occluded in advance in step (B) is set such that in a completely discharged state of the lithium secondary battery when an environmental temperature is 25° C., an amount of lithium releasable from the negative electrode is larger than an irreversible capacity of the lithium secondary battery.

Another lithium secondary battery according to the present invention includes a positive electrode containing a positive electrode active material capable of occluding/releasing lithium ions; a negative electrode containing a negative electrode active material capable of occluding/releasing lithium ions; a separator located between the positive electrode and the negative electrode; and an electrolyte having a lithium ion conductivity. The positive electrode active material contains a lithium transition metal complex oxide having an irreversible capacity; the negative electrode active material has lithium occluded thereto; and in a completely discharged state of the lithium secondary battery when an environmental temperature is 25° C., an amount of lithium releasable from the negative electrode is larger than a capacity increase of the positive electrode at a temperature higher than the environmental temperature and is larger than an irreversible capacity of the positive electrode at the environmental temperature, a pre-occluded amount of lithium of the negative electrode active material is larger than the irreversible capacity of the negative electrode; and a difference between the pre-occluded amount of lithium of the negative electrode active material and the irreversible capacity of the negative electrode is equal to a difference between the amount of lithium releasable from the negative electrode and the irreversible capacity of the positive electrode.

### Advantageous Effects of Invention

According to the present invention, in a lithium secondary battery including a positive electrode containing a lithium transition metal complex oxide as a positive electrode active material and a negative electrode having lithium occluded thereto in advance, an increase in the reversible capacity provided by improvement in polarization in a late stage of discharge of the positive electrode in a high temperature environment can be utilized to increase the capacity of the lithium secondary battery. Therefore, the battery capacity can be increased without the charge/discharge cycle being decreased.

### BRIEF DESCRIPTION OF DRAWINGS

FIG. 1 shows a charge/discharge potential behavior of a nickel-based lithium-containing complex oxide.

FIG. 2 schematically shows discharge curves of a nickel-based lithium-containing complex oxide.

FIG. 3 shows charge/discharge curves of a nickel-based lithium-containing complex oxide when charge/discharge tests are performed under test conditions (a) through (e).

FIG. 4A provides expressions usable to find the temperature dependence of an exchange current density.

FIG. 4B is a graph schematically showing a charge transfer resistance of a positive electrode after an initial cycle and the 500th cycle.

FIG. 4C is a graph showing results of analysis of a deterioration state of a nickel-based lithium-containing complex oxide.

FIG. 5 is a graph showing an example of charge/discharge behavior in a conventional lithium secondary battery using a graphite-based negative electrode active material.

FIG. 6 is a graph showing an example of charge/discharge behavior in a lithium secondary battery in which the negative electrode is caused to occlude lithium in advance.

FIG. 7 is a graph showing an example of charge/discharge behavior in a lithium secondary battery in an embodiment according to the present invention.

FIG. 8 is a graph showing an example of charge/discharge behavior in a conventional lithium secondary battery using a silicon-based negative electrode active material.

FIG. 9 is a graph showing an example of charge/discharge behavior in a lithium secondary battery in which the negative electrode is caused to occlude lithium in advance.

FIG. 10 is a graph showing an example of charge/discharge behavior in a lithium secondary battery in another embodiment according to the present invention.

FIG. 11 shows a charge/discharge behavior of a silicon-based negative electrode.

FIG. 12 shows a charge/discharge behavior of a silicon-based negative electrode after lithium is pre-occluded thereto.

FIG. 13 is a cross-sectional view schematically showing an example of lithium secondary battery in an embodiment according to the present invention.

FIG. 14 is a graph showing an example of discharge curve of a positive electrode active material.

FIG. 15 is a cross-sectional view schematically showing a structure of an electron beam vapor deposition device 50.

FIG. 16 is a cross-sectional view schematically showing a structure of a lithium secondary battery according to the present invention.

FIG. 17 shows a charge/discharge behavior of a cobalt-based lithium-containing complex oxide.

### DESCRIPTION OF EMBODIMENTS

The present inventor found that it is difficult to, among the above-described problems, realize a large capacity while keeping a cycle characteristic thereof high with a conventional lithium secondary battery using a nickel-based lithium-containing complex oxide as a positive electrode active material (e.g., batteries described in Patent Documents 1 through 4) when the battery is used in a high temperature environment.

Therefore, an object of the present invention is to, in a lithium secondary battery using a lithium transition metal complex oxide, especially, a nickel-based complex oxide, as a positive electrode active material, increase the battery capacity while suppressing decrease in the charge/discharge cycle characteristic when the lithium secondary battery is used at a temperature higher than room temperature.

The present inventor made active studies in order to provide both of a large capacity and a high cycle characteristic of a lithium secondary battery using a lithium transition metal complex oxide in a high temperature environment. As a result of the studies, the following was found: When a lithium secondary battery is in a completely discharged state at 25° C., the negative electrode is caused to occlude lithium in advance such that a reversible (releasable) amount of lithium contained in the negative electrode is larger than an irreversible capacity of the lithium secondary battery; in this case, a large capacity is realized in a high temperature environment without the cycle characteristic being decreased. The “amount of releasable lithium contained in the negative electrode” is an amount of lithium occluded in the negative electrode excluding an amount which is not released (irreversible capacity of the negative electrode).

During the process of the studies, it was found that the temperature dependence of the irreversible capacity of the positive electrode active material is closely related to the filling density and the particle diameter of the positive electrode active material. The present inventor made further studies and found that when a lithium transition metal complex oxide other than the nickel-based lithium-containing complex oxide is used, substantially the same tendency as that of the nickel-based lithium-containing complex oxide is exhibited.

Hereinafter, results of the studies made by the present inventor will be described regarding, for example, a case where a nickel-based lithium-containing complex oxide is used as a lithium transition metal complex oxide.

<Relationship Between the Environmental Temperature and the Charge/Discharge Potential Behavior>

FIG. 1 is a graph showing a representative charge/discharge potential behavior (25° C.) of a nickel-based lithium-containing complex oxide. The graph in FIG. 1 shows measurement results of a potential change obtained when LiₓNi_{0.815}Co_{0.15}Al_{0.035}O₂ is used as the nickel-based lithium-containing complex oxide and the x value was varied in the range of 0.3≦x≦1.0.

For the measurement, the nickel-based lithium-containing complex oxide was intermittently charged/discharged with a current density of 0.3 mA/cm². During the charge/discharge, the current was paused at a constant interval to measure open-circuit potentials. Each pause time was 1 hour. The current application and pause were repeated consecutively, and the potential behavior with respect to the x value was plotted in FIG. 1. In the graph shown in FIG. 1, spike-shaped potential changes are seen at a plurality of x values. The changes occurred when the charge/discharge was paused at these x values, and the changes each indicate an open-circuit potential at the corresponding point.

As these results indicate, when the x value is in the range of equal to or larger than 0.3 and smaller than 0.8, the difference between the closed-circuit potential and the open-circuit potential during the charge and discharge is small. However, when the x value is equal to or larger than 0.8, the difference between the closed-circuit potential and the open-circuit potential during the discharge gradually increases, and rapidly increases when the x value becomes, for example, larger than about 0.9. This is presumably because the lithium occlusion to the positive electrode active material is slow and thus appears as polarization. It was found through a crystallography based on X-ray diffraction that a part of the crystalline structure of the positive electrode active material, in a state where lithium is occluded by discharging the battery completely until the x value becomes x=1.0, is changed into a structure which is different from the crystalline structure of the positive electrode active material before the charge/discharge.

The relationship between the phenomenon described above with reference to FIG. 1 and the charge/discharge reversibility (charge/discharge cycle characteristic) has not been clarified in detail. The present inventor presumes that when an area in a late stage of the discharge in which the reaction resistance is large is used repeatedly, at least a part of the positive electrode active material is gradually changed into a crystalline phase having a low reversibility, which may lead to an increase in the reaction resistance along with the charge/discharge cycle repletion.

Meanwhile, the present inventor made further studies and clarified that when the environmental temperature is raised (e.g., to 45° C.) or the current density is extremely decreased (e.g., to 0.06 mA/cm²), polarization of an area where the x value is equal to or larger than 0.8 is reduced and thus a usable capacity is increased at a high discharge end potential. Namely, in the graph shown in FIG. 1, the x value at which the polarization is rapidly increased during the discharge is around 0.9, and the x value at which the potential change is rapidly increased is around 0.8. When the environmental temperature or the current density is changed, such x values may be changed. Hereinafter, this will be described by way of specific examples.

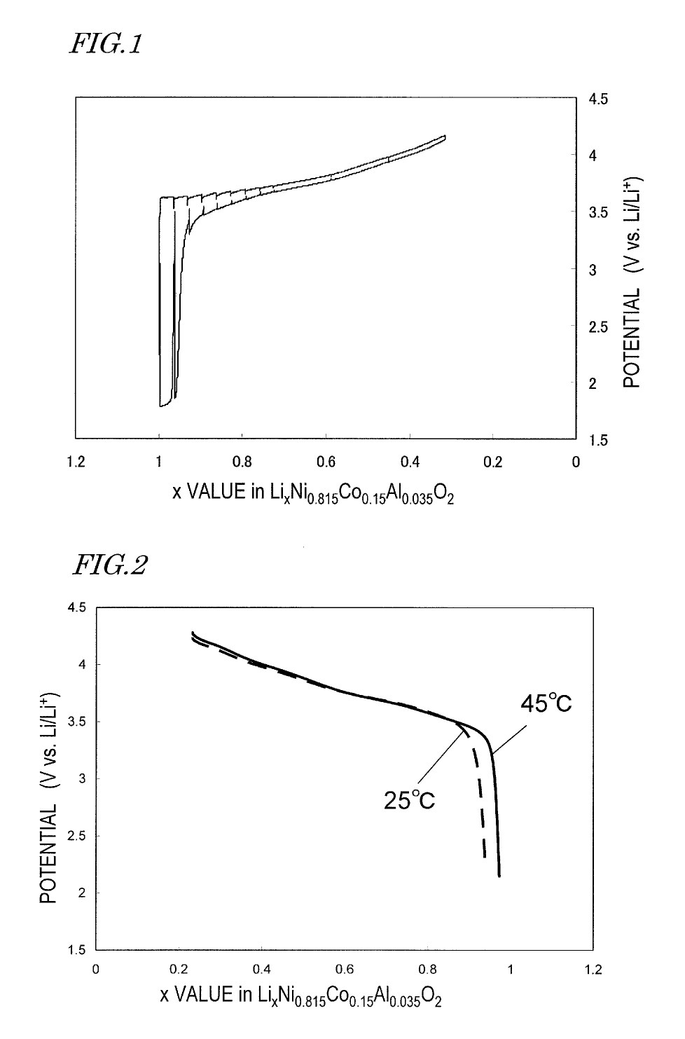

FIG. 2 is a graph showing discharge potential curves of a positive electrode using a nickel-based lithium-containing complex oxide as a positive electrode active material. The discharge potential curves were found where LiNi_{0.815}Co_{0.15}Al_{0.035}O₂ was used, and the current density was 3.0 mA/cm², the charge end potential was 4.25 V, and the discharge end potential was 2.0 V. The environmental temperature was set to 25° C. and 45° C.

As can be seen from the results shown in FIG. 2, in an area where the x value is equal to or smaller than 0.8, the discharge potential is not changed almost at all in accordance with the temperature. When the x value exceeds 0.8, the potential change is rapidly increased at the environmental temperature is 25° C., whereas the potential change is small at the environmental temperature is 45° C. At the environmental temperature is 25° C., polarization is increased when the x value exceeds, for example, 0.9. At the environmental temperature is 45° C., the polarization is kept small even when the x value exceeds 0.9, and increases when the x value exceeds 0.95. At the environmental temperature is 45° C., the capacity is larger by about 6% than at the environmental temperature is 25° C. As can be seen, when the temperature is raised, the discharge capacity is increased although the potential profile in a late stage of the discharge is kept the same.

<Relationship Between the Discharge Capacity and the Reversibility of the Positive Electrode Active Material and the Environmental Temperature>

It was confirmed from the above study results that when the environmental temperature is raised, the discharge capacity of the positive electrode is increased. Next, the present inventor examined the charge/discharge reversibility of the positive electrode active material by changing the environmental temperature or the like while keeping the discharge capacity the same.

Herein, an evaluation cell was produced and charge/discharge tests (a) through (d) were performed. In tests (a) through (c), the evaluation cell was discharged until the discharge capacity (x value) became the same value (herein, 0.96) under different conditions. For comparison, in charge/discharge test (d), charge/discharge was performed in a range of usual potential of use of the positive electrode active material. From the results of these tests, it was found that even when the x value at the discharge end is the same, the charge/discharge reversibility of the positive electrode may vary depending on the environmental temperature or the range of potential of use of the positive electrode. Hereinafter, the method and results of the tests will be described specifically.

(1-1) Production of a Positive Electrode Active Material

First, an aqueous solution containing nickel sulfate at a concentration of 0.815 mol/L, an aqueous solution containing cobalt sulfate at a concentration of 0.15 mol/L, and an aqueous solution containing aluminum sulfate at a concentration of 0.035 mol/L were prepared and mixed. Next, the mixed aqueous solution was continuously supplied into a reaction vessel. Then, sodium hydroxide was dripped to the reaction vessel such that the aqueous solution in the reaction vessel would be maintained at a pH between 10 and 13, and thus a precursor of the active material was synthesized. The resultant precursor was washed well with water, and dried. In this manner, a hydroxide expressed by Ni_{0.815}Co_{0.15}Al_{0.035}(OH)₂ was obtained as the precursor.

The resultant precursor and lithium carbonate were mixed such that lithium, cobalt, nickel and aluminum would have a molar ratio (Ni:Co:Ni:Al) of 1:0.815:0.15:0.035. In an oxygen atmosphere, the mixture was prebaked at a temperature of 500° C. for 7 hours, and pulverized. Next, the pulverized bake was baked again at a temperature of 800° C. for 15 hours. The bake was pulverized and then subjected to a size classification. Thus, a positive electrode active material having a composition represented by LiNi_{0.815}Co_{0.15}Al_{0.035}O₂ was obtained.

(1-2) Production of a Positive Electrode (Working Electrode)

100 g of a powder of positive electrode active material obtained by the method described in (1-1) above was mixed well with 2 g of acetylene black (conductive agent), 2 g of artificial graphite (conductive agent), 3 g of polyvinylidene difluoride powder (binder) and 50 ml of organic solvent (NMP) to prepare a mixture paste. This mixture paste was applied to one surface of an aluminum foil (positive electrode current collector) having a thickness of 15 μm. The mixture paste was dried to obtain a positive electrode active material layer.

Then, the aluminum foil having the positive electrode active material layer formed thereon was rolled to form the working electrode. The thickness of the working electrode, namely, the total thickness of the current collector and the positive electrode active material layer, was 65 μm, and the working electrode capacity per unit area was 3.0 mAh/cm². This working electrode capacity was a capacity in the case where lithium metal was used for the negative electrode and constant-current charge/discharge was conducted under conditions of charge current value: 0.1 mA/cm²; end voltage: 4.25 V; discharge current value: 0.1 mA/cm²; and end voltage: 3.0 V.

(1-3) Production of a Negative Electrode (Counter Electrode)

100 g of artificial graphite as a negative electrode active material, 2.5 g of “BM-400B (trade name)” manufactured by Zeon Corporation (aqueous dispersion containing 40% by weight of denatured styrene-butadiene copolymer) as a binder, 1 g of CMC as a thickener, and an appropriate amount of water were stirred by a planetary mixer to prepare a mixture paste. This mixture paste was applied on one surface of an electrolytic copper foil having a thickness of 10 μm. Then, the mixture paste was dried to obtain a counter electrode active material layer.

Next, the electrolytic copper foil having the active material layer formed thereon was rolled to obtain the counter electrode having a thickness of 80 μm. In order to evaluate the performance of the working electrode, the capacity of the counter electrode was made larger than that of the working electrode. Specifically, the negative electrode capacity per unit area was 4.1 mAh/cm². This negative electrode capacity was a capacity in the case where lithium metal was used for the counter electrode and constant-current charge/discharge was conducted under conditions of charge current value: 0.1 mA/cm²; end voltage: 0 V; discharge current value: 0.1 mA/cm²; and end voltage: 1.5 V.

In order to prevent the discharge end voltage of the evaluation cell from being affected by a change in the discharge potential of the negative electrode in an evaluation test described below, the negative electrode was caused to electrochemically occlude lithium equivalent to 0.5 mAh/cm² in advance. The “electrochemical occlusion of lithium” was performed as follows. Apart from the evaluation cells, a cell for preliminary charge was produced. For the cell for preliminary charge, the negative electrode of the evaluation cells was used as the positive electrode, and lithium metal was used for the negative electrode. The cell for preliminary charge was merely charged to have the positive electrode (i.e., negative electrode of the evaluation cells) occlude lithium. As a result, in a late stage of the discharge, the point in time at which the negative electrode potential rises can be sufficiently delayed from the point in time at which the positive electrode potential significantly drops. Therefore, in the evaluation test, the potential of the negative electrode can be made generally flat.

In this manner, the charge/discharge reversibility of a positive electrode active material in the case where a flat potential area of artificial graphite is used as the counter electrode and the discharge end conditions and the environmental temperature is changed can be evaluated. The irreversible capacity of the negative electrode active material was 0.35 mAh/cm². Namely, the reversible capacity contained at the time of discharge was 0.15 mAh/cm².

(1-4) Production of an Evaluation Cell

As an evaluation cell, a stacked-type cell including an electrode group which includes a stack of a positive electrode, a separator and a negative electrode is used.

FIG. 13 is a cross-sectional view schematically showing a structure of the evaluation cell used in this example.

The evaluation cell includes a positive electrode 11, a negative electrode 12, a separator 13, a positive electrode lead 14, a negative electrode lead 15, a gasket 16, and an outer case 17. The positive electrode produced in (1-2) above is used as the positive electrode 11, and the negative electrode produced in (1-3) above is used as the negative electrode 12. The positive electrode 11 includes a positive electrode current collector 11a and a positive electrode active material layer 11b, whereas the negative electrode 12 includes a negative electrode current collector 12a and a negative electrode active material layer 12b. The separator 13 is located between the positive electrode active material layer 11b and the negative electrode active material layer 12b. The positive electrode lead 14 is connected to the positive electrode current collector 11a, and the negative electrode lead 15 is connected to the negative electrode current collector 12a. An electrode group including the positive electrode 11, the negative electrode 12 and the separator 13 is contained in the outer case 17 together with an electrolyte.

Next, a method for producing the evaluation cell will be described.

The working electrode produced in (1-2) above was cut into a size of 20 mm×20 mm to obtain the positive electrode 11. Similarly, the counter electrode obtained in (1-3) above was cut into a size of 20 mm×20 mm to obtain the negative electrode 12. Next, the positive lead 14 and the negative lead 15 were welded respectively to parts of the current collectors 11a and 12a of the positive electrode 11 and the negative electrode 12 where the active material layers 11b and 12b were not formed.

Then, the positive electrode 11, the separator 13, and the negative electrode 12 were stacked such that the positive electrode active material layer 11b and the negative electrode active material layer 12b would face each other while having the separator (polyethylene microporous film) 13 therebetween to produce the electrode group. The electrode group was inserted into the outer case 17, formed of an aluminum laminate, together with 0.5 g of electrolyte. The electrolyte was produced as follows: ethylene carbonate (EC), ethyl methyl carbonate (EMC) and diethyl carbonate (DEC) were mixed at a volume ratio of EC:EMC:DEC=2:3:5, and LiPF₆ was dissolved in the resultant mixture solvent at a concentration of 1.0 mol/L. Then, vinylene carbonate was added at a weight ratio of 2%. Thus, the electrolyte solution was obtained.

Next, lithium metal was prepared as a reference electrode. The reference electrode (not shown) was located in the vicinity of the positive electrode 11 in the outer case 17. The positive electrode lead 14, the negative electrode lead 15 and a reference electrode lead (not shown) were allowed to extend outside the outer case 17 through openings of the outer case 17. Then, the openings of the outer case 17 were welded while the inner pressure of the outer case 17 was vacuum-reduced. In this manner, the evaluation cell was obtained.

(1-5) Evaluation on the Initial Capacity and the Charge/Discharge Reversibility (Charge/Discharge Cycle Characteristic)

Next, the initial capacity of the evaluation cell was found. In addition, a charge/discharge test was performed on the evaluation cell under test conditions (a) through (d) described below to find the relationship between the initial capacity and the charge/discharge reversibility of the positive electrode active material.

First, the first cycle of charge/discharge was conducted under the following conditions.

(Conditions for Initial Capacity Evaluation)

Constant-current charge: 0.7 CmA; end voltage: 4.2 V

Constant-voltage charge: end current: 0.05 CmA; pause time: 20 minutes

Constant-current discharge: 0.2 CmA; end voltage (as shown in the table); pause time: 20 minutes

Test temperature: as shown in the table

After conducting the first cycle of charge/discharge, a discharge capacity per active material weight of the positive electrode (working electrode) in the first cycle of charge/discharge was calculated, which was defined as the “usable capacity (mAh/g)”. The usable capacities are shown in Table 1.

Moreover, the lithium contents in the positive-electrode active material at the end of the charge and at the end of the discharge (discharge end), namely, the x values in the composition LiₓNi_{0.815}Co_{0.15}Al_{0.035}O₂ of the positive electrode active material, were examined. The x values at the discharge end are shown in Table 1. In all of tests (a) through (d), the x value at the end of the charge was 0.232.

Next, the discharge current value was increased, and second and subsequent cycles of charge/discharge were performed under the following conditions.

(Conditions for Charge/Discharge Reversibility Evaluation)

Constant-current charge: 0.7 CmA; end voltage: 4.2 V

Constant-voltage charge: end current: 0.05 CmA; pause time: 20 minutes

Conditions of constant-current discharge and test temperature
Test (a) Test temperature: 25° C.; 0.2 C; end potential: 1.75 V
Test (b) Test temperature: 25° C.; 1.0 C+0.2 C+0.05 C+0.02 C; end potential: 2.65 V
Test (c) Test temperature: 45° C.; 0.2 C; end potential: 2.65 V
Test (d) Test temperature: 25° C.; 0.2 C; end potential: 2.65 V

1.0 C=12 mAh. In all of tests (a) through (d), the pause time of the constant-current discharge was 20 minutes.

In tests (a) through (d), the cells were discharged until having the same discharge capacity (x=0.96). In test (a), the test temperature was 25° C., and the current density was 0.2 C. The positive electrode potential when the x value was 0.96 was set as the discharge end potential. In test (b), the test temperature was 25° C., and the current density was set to a very low value so that the positive electrode potential would not be equal to or lower than 2 V (area of rapid decrease of the potential). The discharge was performed until the x value became was 0.96. In test (c), the test temperature was 45° C., and the cell was discharged until having the same discharge capacity as above (x=0.96). The discharge end potential was 2.65 V, which was the same as that in test (b). In test (d), for comparison, standard charge/discharge was performed with a test temperature of 25° C., a current density of 0.2 C, and a discharge end potential of 2.65 V.

After the charge/discharge was repeated under the above-described conditions, the capacity decrease amount after the n'th cycle was divided by the number of cycles n, and the resultant value was set as the “capacity deterioration ratio (% cycle)”. Herein, 500 cycles of charge/discharge was performed (n=500), and the capacity deterioration ratio after the 500th cycle was found. The results are shown in Table 1.

TABLE 1

| | | Positive | X value | | | Capacity |
|---|---|---|---|---|---|---|
| | Discharge | electrode | at | Test | Usable | deterioration |
| Test | end voltage | discharge end | discharge | temper- | capacity | ratio |
| conditions | of cell (V) | potential (V) | end | ature | (mAh/g) | (%/cycle) |
| (a) | 1.6 | 1.75 | 0.96 | 25° C. | 202 | 0.333 |
| (b) | 2.5 | 2.65 | 0.96 | 25° C. | 202 | 0.074 |
| (c) | 2.5 | 2.65 | 0.96 | 45° C. | 202 | 0.041 |
| (d) | 2.5 | 2.65 | 0.92 | 25° C. | 202 | 0.050 |

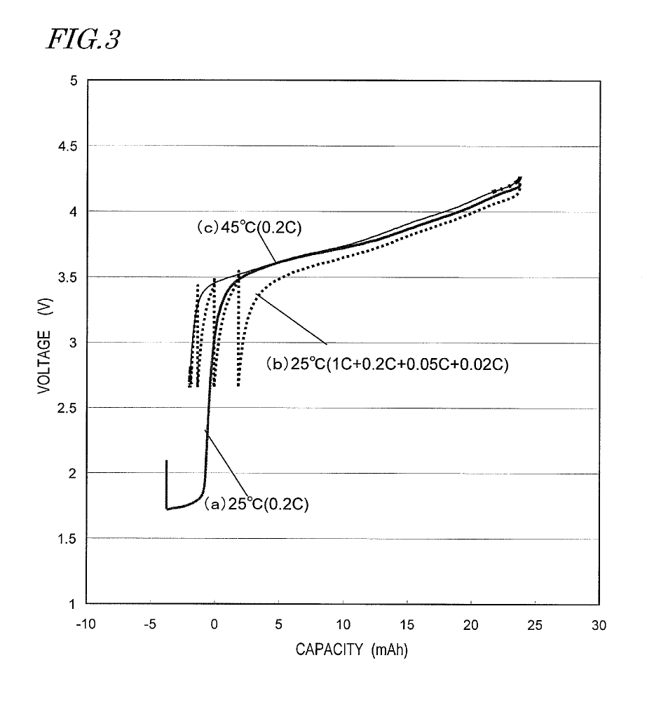

FIG. 3 shows discharge curves of the positive electrode active material in tests (a) through (c). The horizontal axis represents the capacity (mAh), and the vertical axis represents the discharge voltage (V).

In tests (a) through (c), the discharge conditions other than the test temperature were the same. It was found from the capacity deterioration ratio and the usable capacity obtained in these tests that when the test temperature is higher than room temperature, both of the usable capacity and the reversibility can be improved. The usable capacity is 202 mAh/g in all of tests (a) through (c). Meanwhile, the capacity deterioration ratio was highest in test (a), next highest in test (b), and lowest in test (c). From this, it was confirmed that when the discharge end potential of the positive electrode is low (test (a)), the reversibility is lower than in the case where the discharge end potential is high (test (b)). It was also found that even when the discharge end potential of the positive electrode is the same, the reversibility can be improved when the test temperature is higher than room temperature (test (c)).

As can be seen from these results, when the test temperature is high (test (c)), both of a large capacity and a high reversibility can be provided. A conceivable reason for this is that when the test temperature is higher than room temperature (herein, 45° C.), the charge transfer resistance (reaction resistance) can be decreased in the entirety of charge/discharge, not only in a late stage of the discharge, and therefore the deterioration in the reversibility can be suppressed.

Next, the deterioration state of the positive electrode active material was compared between the test temperature of 25° C. and the test temperature of 45° C.

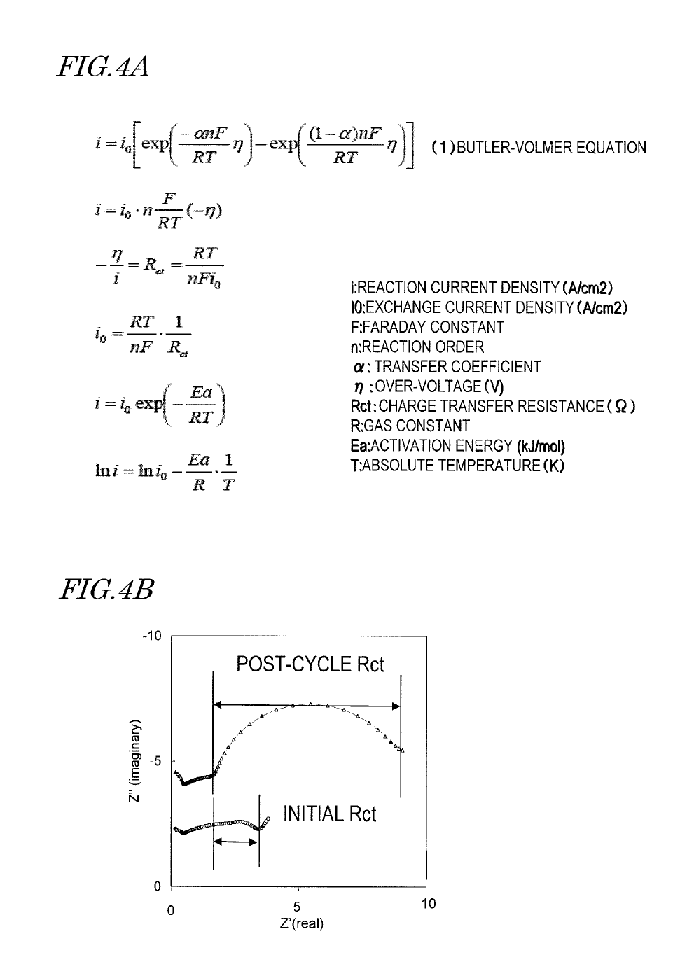

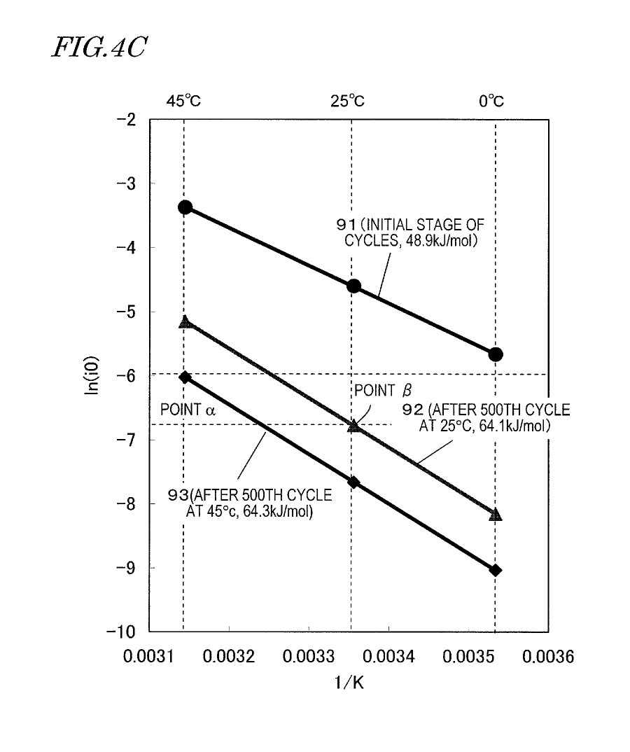

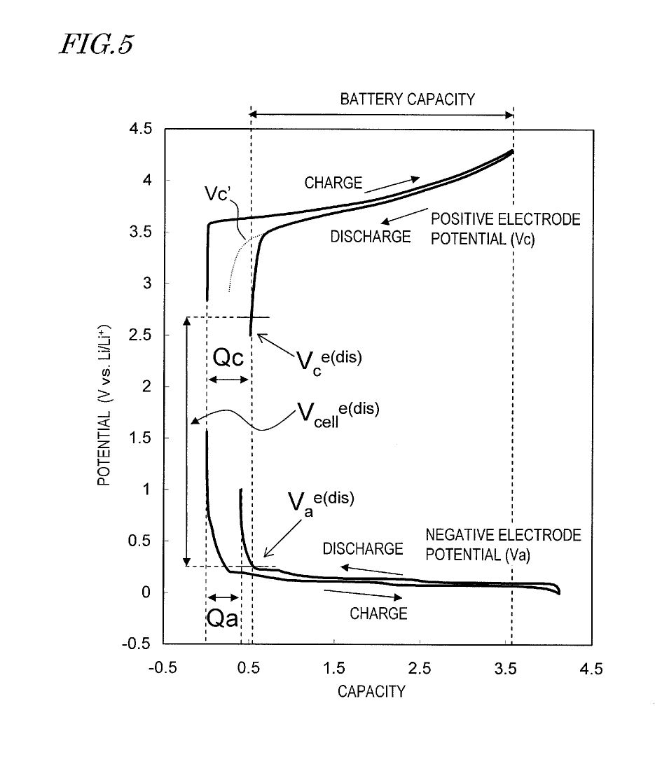

First, the temperature dependence of the charge transfer resistance of the positive electrode was measured based on the AC impedance in a charged state, and the temperature dependence of the exchange current density was examined in accordance with the expressions in FIG. 4A. FIG. 4B is a graph schematically showing the charge transfer resistance of the positive electrode in an initial stage of the charge/discharge and after the 500th cycle. FIG. 4C shows Arrhenius plots (lines 93, 94 and 95) regarding the oxidation/reduction reaction of the positive electrode in the initial stage of the charge/discharge and the positive electrodes after 500 cycles of the charged/discharged performed at 25° C. and 45° C.

In FIG. 4C, the horizontal axis represents the inverse number of the absolute temperature K, and the vertical axis represents the exchange current density io (logarithmic representation) of the oxidation/reduction reaction of the positive electrode. The graph exhibits that as the value of the exchange current density io is larger, the reaction proceeds more easily. All graphs 91 through 93 show that as the absolute temperature rises, the value of the exchange current density io increases.

The gradient of each line represents the activation energy. The activation energy in the oxidation/reduction reaction of the positive electrode in the initial stage of the charge/discharge and the positive electrodes after 500 cycles of the charged/discharged performed at 25° C. and 45° C. were respectively 48.9 kJ/mol, 64.1 kJ/mol, and 64.3 kJ/mol.

As can be seen, the activation energy of the positive electrode after 500 cycles of the charged/discharged (i.e., the gradient of graphs 92 and 93) is approximately the same regardless of the test temperature. Graph 92 (test temperature: 25° C.) is above graph 93 (test temperature: 45° C.), which indicates that the reaction occurs more easily (i.e., the cycle deterioration is smaller) at the test temperature of 25° C. However, the exchange current density io point α of graph 93 (test temperature: 45° C.) is higher than the exchange current density io of point β of graph 92 (test temperature: 25° C.). This indicates that the apparent cycle deterioration is smaller when the test temperature is 45° C. than when the test temperature is 25° C.

From these test results, the present inventor obtained the knowledge that the capacity and the cycle characteristic can be improved by designing a battery in consideration of use at a high temperature (e.g., 45° C.) instead of designing a battery with a premise that the battery will be used at room temperature.

When a battery is used at room temperature, the x value is higher than 0.92 in a low area of the voltage of the positive electrode (equal to or lower than 2 V). Therefore, when the battery is discharged until the x value exceeds 0.92 for the purpose of improving the capacity, the cycle characteristic of the positive electrode active material is decreased. In addition, the voltage area of use of the positive electrode is set to exceed 2 V because of the restriction on the voltage of the device. A usual battery cannot be discharged until the voltage of the positive electrode becomes equal to or lower than 2 V. Only when the battery is used in a high temperature environment, the x value exceeds 0.92 in the voltage area of use of the positive electrode. Thus, the capacity can be improved with no decrease in the cycle characteristic. As can be seen from this, it is very important that the positive electrode potential, the negative electrode potential, and the battery voltage in a late stage of the discharge should be made appropriate such that the performance is maximized at a high temperature (e.g., 45° C.).

<Relationship Between the Discharge Potential Behavior and the Irreversible Capacity>

First, the relationship between the discharge potential behavior and the irreversible capacity will be described regarding, for example, a lithium secondary battery using a graphite-based material as a negative electrode active material and a lithium transition metal complex oxide (herein, a nickel-based lithium-containing complex oxide) as a positive electrode active material.

FIG. 5 is a graph showing an example of charge/discharge behavior at 25° C. of a conventional lithium secondary battery using a graphite-based material as a negative electrode active material and a nickel-based lithium-containing complex oxide as a positive electrode active material. The vertical axis represents the potential on a lithium metal basis, and the horizontal axis represents the relative capacity. In FIG. 5, the positive electrode potential is represented by Vc, and the negative electrode potential is represented by Va. The battery voltage Vcell at the time of charge/discharge is represented by a difference between the positive electrode potential and the negative electrode potential (=Vc−Va).

As can be seen from this graph, the positive electrode potential Vc slowly falls from the start of the discharge and then rapidly drops in a last stage of the discharge. The negative electrode potential Va rises very slowly from the start of the discharge. In the last stage of the discharge, the potential change gradually increases, and the negative electrode potential Va rapidly rises.

In this system, before the potential change of the negative electrode potential Va becomes large, the positive electrode potential Vc rapidly drops. At this point, the difference between the positive electrode potential Vc and the negative electrode potential Va (i.e., cell voltage) becomes equal to or lower than a prescribed voltage, and thus the discharge is finished. The positive electrode potential at the end of the discharge will be referred to as the “discharge end potential Vc^{e(dis)} of the positive electrode”, and the negative electrode potential at the end of the discharge will be referred to as the “discharge end potential Va^{e(dis)} of the negative electrode”. The prescribed voltage will be referred to as the “discharge end voltage Vcell^{e(dis)} of the cell”. In this example, the discharge end voltage Vcell^{e(dis)} of the cell is set to, for example, 2.5 V. An irreversible capacity Qc of the positive electrode is the irreversible capacity of the cell.

In this manner, it is devised that the irreversible capacity Qc of the positive electrode and an irreversible capacity Qa of the negative electrode are cancelled by each other.

As described above with reference to FIG. 2, when the temperature at which the batter is used becomes 45° C., the profile of the positive electrode potential Vc is changed such that the capacity is increased. Namely, as represented by curve Vc′ in FIG. 5, the point at which the positive electrode potential Vc rapidly falls is shifted leftward. However, even when the profile of the positive electrode potential Vc is changed in this manner, the negative electrode potential Va rapidly rises before the positive electrode potential Vc rapidly falls. At the point of the rapid rise of the negative electrode potential Va, the discharge is finished (negative potential regulation). Therefore, the actual value (about 1%) of the capacity increase is significantly smaller than the a value of the capacity of the positive electrode which should be increased by use of the battery at 45° C.

By contrast, by having the negative electrode occlude lithium in advance, the charge start position of the positive electrode potential Vc can be shifted rightward in FIG. 5. The expression “have the negative electrode occlude lithium in advance” means that in a process for producing a lithium secondary battery, the negative electrode (negative electrode active material) is caused to occlude lithium before the negative electrode and the positive electrode are located to face each other while having a separator therebetween to form an electrode group.

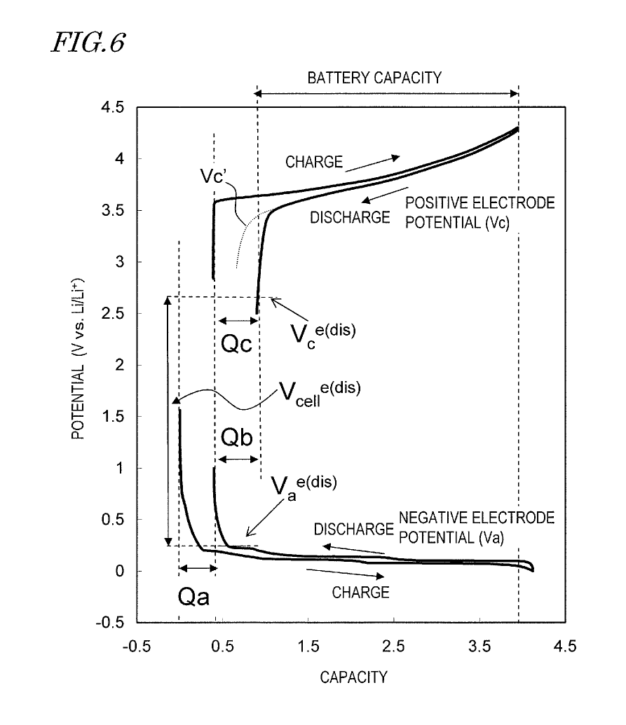

FIG. 6 is a graph showing an example of charge/discharge behavior at 25° C. of a lithium secondary battery having the negative electrode occlude lithium in advance in the same amount as that of the irreversible capacity Qa.

In the graph shown in FIG. 5, the relative capacity of the charge start point is smaller than the relative capacity of the point at which the negative electrode potential Va rises. By contrast, in the graph shown in FIG. 6, the relative capacity of the charge start point approximately the same as the relative capacity of the point at which the negative electrode potential Va rises because the lithium of an amount corresponding to the irreversible capacity is occluded to the negative electrode. Therefore, in a completely discharged state at 25° C., the releasable (reversible) amount of lithium Qb in the negative electrode is equal to the irreversible capacity of the battery, namely, the irreversible capacity Qc of the positive electrode. In this specification, the expression “in a completely discharged state at 25° C.” indicates a state where the battery is discharged at a current of 0.2 C until the battery voltage becomes 2.5 V.

When lithium is occluded to the negative electrode in advance, the charge start point of the negative electrode is shifted rightward (direction in which the capacity is increased). Therefore, in FIG. 6, a part of the profile of the negative electrode potential Va that is rightward to the charge start point is the charge/discharge curve in an actual lithium battery.

According to the studies made by the present inventor, with the structure of the battery shown in FIG. 6, even when the temperature of use of the battery becomes high (e.g., 45° C.) and thus the discharge potential of the positive electrode is changed as represented by dotted line Vc′, the discharge end point is controlled by the positive electrode potential Vc (positive electrode potential regulation). Therefore, an increase ΔC of the positive electrode capacity obtained by raising the temperature of use of the battery can be used as the capacity of the battery.

However, with the structure of the battery shown in FIG. 6, when the point at which the discharge potential Vc of the positive electrode rapidly falls is shifted further leftward, the discharge may be undesirably finished before the point at which the discharge potential of the positive electrode rapidly falls, by an influence of the potential change in the vicinity of the point at which the negative electrode potential Va rises. When this occurs, the battery capacity is smaller than in the case where the discharge is finished at the point where the positive electrode potential rapidly falls.

The present inventor found that when the negative electrode is caused to occlude lithium in an amount larger than the irreversible capacity Qa of the negative electrode, the influence on the positive electrode potential Vc by the rise of the negative electrode potential Va is prevented and thus the positive electrode potential regulation can be maintained with more certainty.

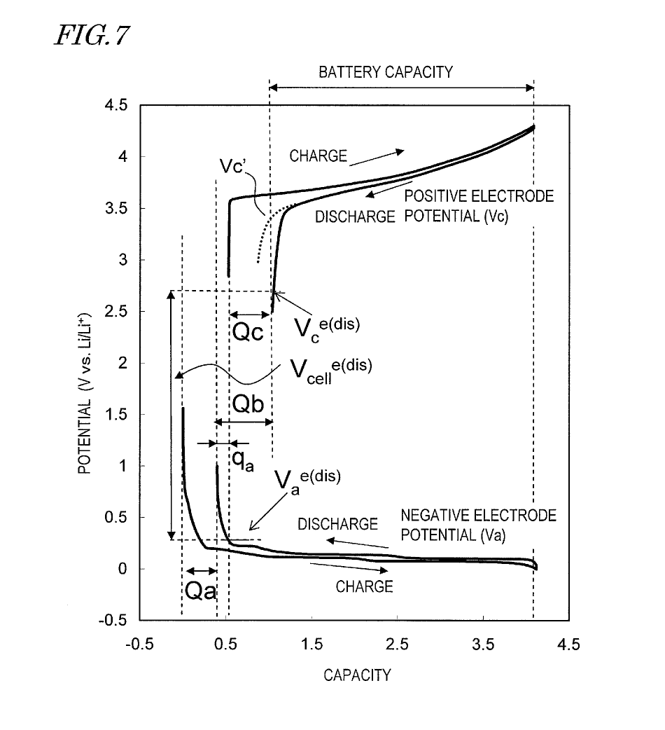

FIG. 7 is a graph showing another example of charge/discharge behavior at 25° C. of a lithium secondary battery having the negative electrode occlude lithium in advance. In this example, lithium in an amount larger than the irreversible amount Qc (Qa+qa) is occluded to the negative electrode.

The excessive amount qa of lithium occluded to the negative electrode is a reversible capacity of the negative electrode. In addition, lithium of the irreversible capacity (Qc) of the positive electrode is present in the negative electrode in a discharged state. Therefore, in a completely discharged state at 25° C., the amount Qb of lithium releasable from the negative electrode is larger than the irreversible capacity of the battery, namely, the irreversible capacity Qc of the positive electrode. Specifically, the negative electrode contains, as movable lithium, lithium in an amount Qb equal to a sum of the excessive amount qa of lithium and the irreversible capacity Qc of the positive electrode (i.e., the irreversible capacity of the battery).

In the graph of FIG. 7, the relative capacity of the charge start point is larger than the relative capacity of the point at which the negative electrode potential Va rises. Therefore, even when the temperature of use of the battery becomes high (e.g., 45° C.) and thus the discharge potential of the positive electrode is changed as represented by dotted line Vc′, the discharge end point is controlled by the positive electrode potential Vc (positive electrode potential regulation). As a result, a part of a movable amount Qb (=qa+Qc) of lithium present in the negative electrode is inserted into the positive electrode, and thus the discharge capacity of the battery is increased.

According to the structure of the battery shown in FIG. 7, the discharge end is not easily influenced by the potential change in the vicinity of the point at which the negative electrode potential Va rises. Therefore, the discharge can be finished with more certainty at the time when the discharge potential Vc of the positive electrode rapidly falls, regardless of the environmental temperature. Accordingly, the capacity increase of the positive electrode provided by the rise in the environmental temperature can be reflected on the increase in the battery capacity with no loss. Thus, the battery capacity can be increased under a high temperature environment.

The excessive amount qa of lithium may be any value larger than 0 (qa>0). When a graphite-based material is used as the negative electrode active material, the excessive amount qa of lithium is preferably at least 0.1 times the irreversible capacity Qa of the negative electrode (qa≦Qa×0.1), and more preferably at least 0.5 times the irreversible capacity Qa of the negative electrode (qa≦Qa×0.5). Therefore, the amount of lithium to be occluded to the negative electrode in advance is preferably at least 1.1 times and more preferably at least 1.5 times the irreversible capacity Qa of the negative electrode. In such a case, the influence of the rise of the negative electrode potential Va on the positive electrode potential Vc can be reduced more effectively.

Meanwhile, when the amount of lithium to be occluded to the negative electrode in advance is too large, there is an undesirable possibility that a sufficiently large battery capacity cannot be provided with certainty. When a graphite-based material is used as the negative electrode active material, the excessive amount qa of lithium is preferably at most 2.0 times the irreversible capacity. Therefore, it is preferable that the amount of lithium to be occluded to the negative electrode in advance is at most 3.0 times the irreversible capacity Qa of the negative electrode.

Next, the present inventor studied the relationship between the discharge potential behavior and the irreversible capacity in the case where an alloy material of silicon or the like as a negative electrode active material instead of the graphite-based material. The results will be described.

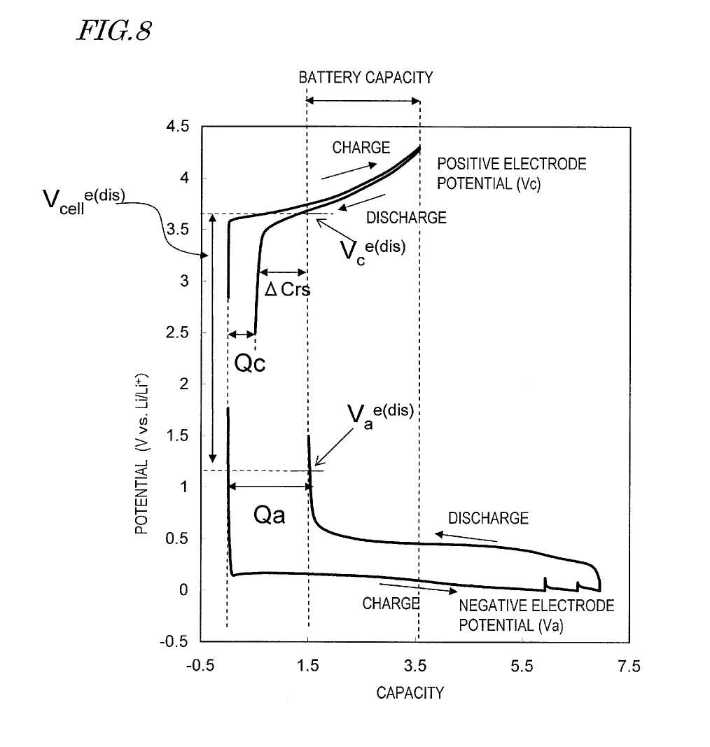

First, a charge/discharge behavior of a conventional lithium secondary battery in which the negative electrode is not caused to occlude lithium in advance will be described. FIG. 8 shows an example of charge/discharge behavior at 25° C. of a lithium secondary battery including a negative electrode having a structure in which SiO_{0.25} in the form of a film is deposited on a substrate and a positive electrode containing a nickel-based lithium-containing complex oxide as a positive electrode active material.

As shown in FIG. 8, in this battery, the irreversible capacity Qa of the negative electrode is larger than the irreversible capacity Qc of the positive electrode (Qa>Qc). Therefore, the time to finish the discharge is regulated by the negative electrode potential (negative electrode potential regulation). A part of the positive electrode capacity (ΔCrs shown in FIG. 8) is not usable at 25° C.

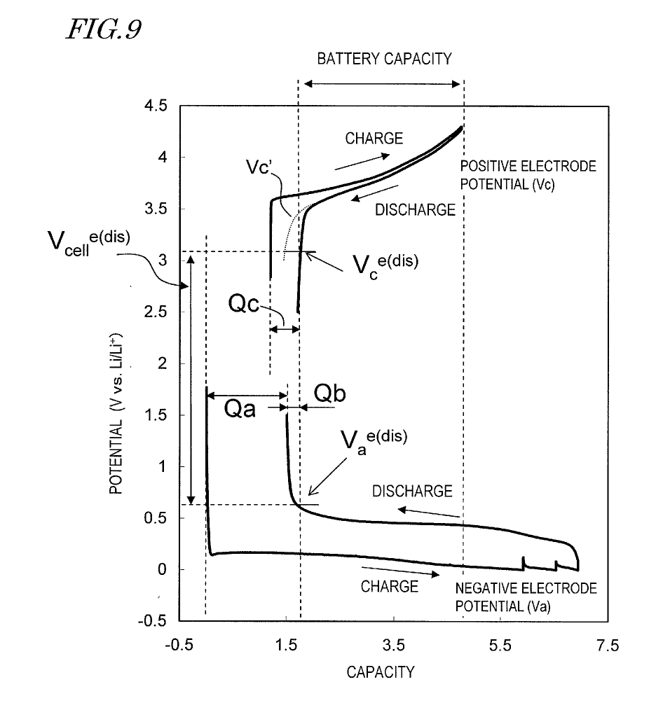

When the negative electrode of this battery is caused, in advance, to occlude lithium in an amount 0.9 times the irreversible capacity Qa of the negative electrode (0.9×Qa), a charge/discharge behavior shown in FIG. 9 is obtained at 25° C. As shown in FIG. 9, when the battery is used at 25° C., the time to finish the discharge is regulated by the positive electrode potential. Therefore, most of the positive electrode capacity is usable as the battery capacity. However, since the gradient of the negative electrode potential is large in a late stage of the discharge, capacity loss is caused.

With the structure of the battery shown in FIG. 9, in a completely discharged state at 25° C., the amount Qb of lithium releasable from the negative electrode is smaller than the irreversible capacity of the battery, namely, the irreversible capacity Qc of the positive electrode. When such a battery is used at a high temperature (e.g., 45° C.), the discharge potential of the positive electrode is changed as represented by, for example, dotted line Vc′. This may result in negative electrode potential regulation. Therefore, a part of the increase in the positive electrode capacity provided by the use of the battery at a high temperature is not reflected on the increase in the battery capacity.

By contrast, when the negative electrode is caused to occlude lithium in an amount larger than the irreversible capacity Qa of the negative electrode in advance, the loss in the increase in the positive electrode capacity can be decreased, and thus a large capacity is realized in a high temperature environment, like with the structure of the battery shown in FIG. 7.

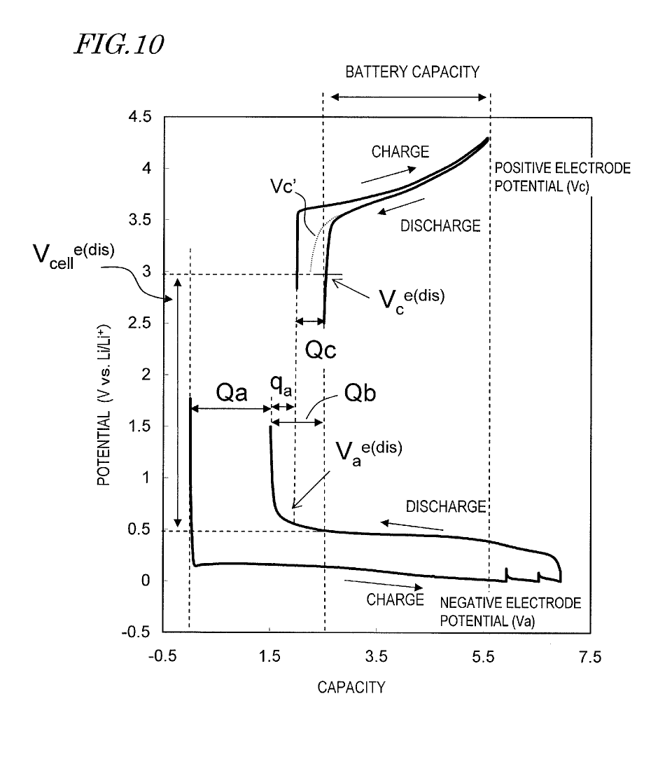

FIG. 10 shows a charge/discharge behavior at 25° C. in the case where the negative electrode is caused to occlude lithium in an amount larger than the irreversible capacity Qa of the negative electrode (Qa+qa) in advance. Herein, the negative electrode is caused, in advance, to occlude lithium in an amount 1.1 times the irreversible capacity Qa (Qa+qa=1.1×Qa). In this example, in a completely discharged state at 25° C., the amount Qb of lithium releasable from the negative electrode is larger than the irreversible capacity of the battery, namely, the irreversible capacity Qc of the positive electrode.

As shown in FIG. 10, when the battery is used at 25° C., the time to finish the discharge is regulated by the positive electrode potential. In addition, the gradient of the negative electrode potential in a late stage of the discharge is smaller than the gradient of the negative electrode potential shown in FIG. 9. When such a battery is used at a high temperature (e.g., 45° C.), the discharge potential of the positive electrode is changed as represented by, for example, dotted line Vc′. However, since the discharge potential Vc′ rapidly falls before the negative electrode potential rises, positive electrode potential regulation is realized. Therefore, the entirety of the increase in the positive electrode capacity provided by the use of the battery at a high temperature can be reflected on the increase in the battery capacity.

The excessive amount qa of lithium may be any value larger than 0 (qa>0). When a silicon-containing material is used as the negative electrode active material, the excessive amount qa of lithium is preferably at least 0.1 times the irreversible capacity Qa of the negative electrode (qa≧Qa×0.1), and more preferably at least 0.3 times the irreversible capacity Qa of the negative electrode (qa≦Qa×0.3). Therefore, the amount of lithium to be occluded to the negative electrode in advance is preferably at least 1.1 times and more preferably at least 1.3 times the irreversible capacity Qa of the negative electrode. In such a case, the influence of the rise of the negative electrode potential Va on the positive electrode potential Vc can be reduced more effectively.

Meanwhile, when the amount of lithium to be occluded to the negative electrode in advance is too large, there is an undesirable possibility that a sufficiently large battery capacity cannot be provided with certainty. When a silicon-containing material is used as the negative electrode active material, it is preferable that the amount of lithium to be occluded to the negative electrode in advance is at most 2.0 times the irreversible capacity Qa of the negative electrode.

During the process of the above-described studies, it was found that when the negative electrode containing silicon is used, the irreversible capacity of the negative electrode tends to decrease as the environmental temperature of the battery rises. A conceivable reason for this is as follows. One factor of the irreversible capacity Qc of the negative electrode is that lithium occluded to the negative electrode is trapped inside the crystalline structure. The irreversible capacity of the negative electrode tends to decrease because when the environmental temperature of the battery rises and thus the lithium diffusion rate is increased, the irreversible capacity caused by the trap of the lithium is decreased.

It was also found that as the environmental temperature rises, the polarization of charge/discharge is decreased. A large hysteresis is present in the charge/discharge potential. A reason for this has not been well clarified, but it was found that as the environmental temperature rises, the hysteresis is decreased.

As described above, when the environmental temperature rises, the irreversible capacity Qa of the negative electrode is decreased and the charge/discharge polarization is decreased. Therefore, the rise of the negative electrode potential in a late stage of the discharge can be further suppressed. Namely, as shown in FIG. 11, when the environmental temperature is 45° C., the point at which the negative electrode potential rises can be shifted toward a lower capacity (leftward in FIG. 11) with respect to the point at which the negative electrode potential rises when the environmental temperature is 25° C. Therefore, even when the environmental temperature rises, the positive electrode potential regulation can be maintained with more certainty.

As can be seen from FIG. 7 through FIG. 10, in this embodiment, a difference between the excessive amount qa of lithium occluded to the negative electrode, namely, the pre-occluded amount of lithium of the negative electrode active material (Qa+qa), and the irreversible capacity Qa of the negative electrode is equal to a difference between the amount Qb releasable of lithium from the negative electrode and the irreversible capacity Qc of the positive electrode.

In the above, the results of studies on the relationship between the discharge potential behavior and the irreversible capacity is described regarding a nickel-base lithium-containing complex oxide. Studies made by the present inventor found that another lithium transition metal complex oxide, for example, a cobalt-based lithium-containing complex oxide, exhibits a similar charge/discharge potential behavior to that of the nickel-base lithium-containing complex oxide shown in FIG. 2 and the relationship between the behavior and the irreversible capacity is substantially the same as that described above.

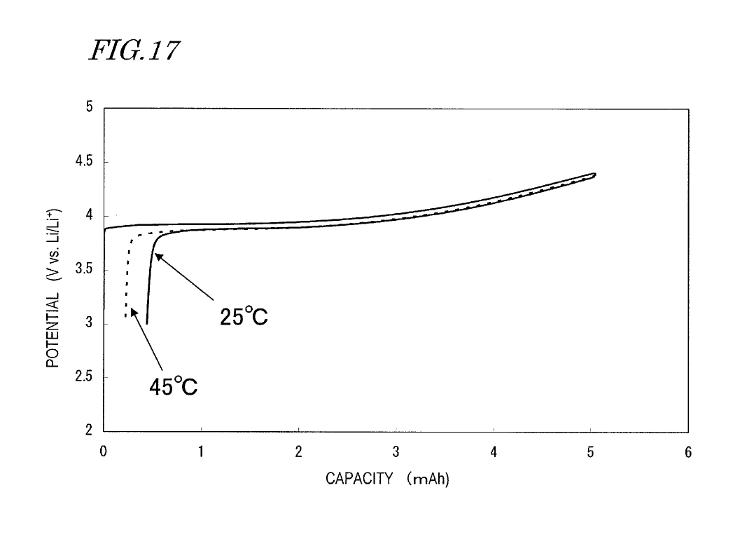

FIG. 17 shows an example of charge/discharge potential behavior of a cobalt-based lithium-containing complex oxide. As can be seen from FIG. 17, in the case of a cobalt-based lithium-containing complex oxide also, the polarization of the discharge is decreased and the capacity is increased at 45° C. Therefore, in a conventional battery using a cobalt-based lithium-containing complex oxide (lithium cobalt oxide) as a positive electrode active material and graphite as a negative electrode active material (battery in which the negative electrode is not caused to occlude lithium in advance), the irreversible capacity of the negative electrode is larger than the irreversible capacity of the positive electrode at 25° C. Therefore, the battery is of a negative electrode capacity regulation type. A conventional battery having a combination of a positive electrode active material containing LCO and a negative electrode containing silicon, which has a larger irreversible capacity ratio than a negative electrode containing graphite, also is of a negative electrode capacity regulation type. Therefore, when such a battery is used in a high temperature environment (e.g., 45° C.) in which the polarization of the positive electrode is decreased and the discharge capacity is increased, the battery capacity is not increased due to the negative electrode capacity regulation. Even in a case of a battery which has the negative electrode occlude lithium in advance and thus becomes of a positive electrode capacity regulation type at room temperature, if the amount of lithium occluded to the negative electrode in advance (pre-occluded amount) is small, a part of the increase in the positive electrode capacity provided by the use of the battery at a high temperature may not be reflected on the increase in the battery capacity.

By contrast, when the negative electrode is caused to occlude lithium in an amount larger than the irreversible capacity Qa of the negative electrode, the battery is of a positive electrode potential regulation type even when used at a high temperature. Therefore, in a battery using a cobalt-based lithium-containing complex oxide also, a large capacity is realized in a high temperature environment.

A surface of the positive electrode active material may be partially or entirely covered with another metal oxide, hydroxide, metal salt or the like for the purpose of, for example, decreasing the oxidative degradation reaction of the electrolyte solution on the positive electrode active material at a high voltage. For example, in the case where LCO having a surface covered with a metal oxide or the like is used as the positive electrode active material, the amount of lithium pre-occluded to the negative electrode can be controlled so that the substantially the same as described above is provided.

### <Method for Having the Negative Electrode to Pre-Occlude Lithium>

Next, the present inventor studied a method for having the negative electrode occlude lithium in advance (pre-occlusion). The results will be described.

There are electrochemical and dry technique for having the negative electrode to occlude lithium.

According to an electrochemical technique, the negative electrode is caused to occlude lithium as follows. Lithium metal is bonded to the negative electrode, and a local battery is formed via an electrolyte solution and charged or lithium is charged from a counter electrode. In order to have the negative electrode occlude lithium uniformly, it is preferable to use a very thin lithium metal layer (thickness: equal to or thinner than 10 μm). However, such a thin lithium metal layer has a problem of being difficult in handling.

A dry technique is performed as follows, for example. Lithium metal is directly put into contact with the negative electrode active material and the negative electrode is caused to occlude lithium metal only through solid phase diffusion. Methods for directly putting lithium metal into contact with negative electrode active material include a method of depositing lithium metal on the negative electrode active material by a vapor deposition method such as a vacuum vapor deposition method or the like, and a method of causing the negative electrode active material to adhere to a substrate having lithium metal deposited thereon and optionally heating the resultant assembly (transfer method).

According to the studies made by the present inventor, when the electrochemical technique or the vapor deposition method such as the vacuum vapor deposition method or the like was used, lithium in an amount larger than the irreversible capacity Qa of the negative electrode was occluded to the negative electrode. By contrast, when the transfer method was used, it was found that the amount of lithium which can be pre-occluded is smaller than the amount when the other techniques are used. A reason for this is that lithium is occluded only to the vicinity of the surface of the negative electrode active material and does not easily enter the inside of the negative electrode active material. With the other techniques such as the vacuum vapor deposition method, lithium can be occluded to the entire surface of the negative electrode active material; whereas with the transfer method, lithium is occluded to a part of the surface of the negative electrode active material (part where the lithium foil is bonded). As a result, the amount of lithium which can be occluded is further decreased.

For the above-described reason, when the transfer method is used, it is difficult to have the negative electrode occlude lithium in an amount larger than the irreversible capacity Qa of the negative electrode in advance, and the amount of lithium releasable from the negative electrode cannot be made larger than the irreversible capacity of the battery. Accordingly, in this embodiment, the electrochemical technique or the vapor deposition method such as the vacuum deposition method or the like is used as the pre-occlusion method of lithium.

The present inventor also found that in the case where a silicon-based material is used as the negative electrode active material, the polarization in a late stage of the discharge can be made smaller when the vapor deposition method is used for having lithium be occluded than when the electrochemical technique is used.

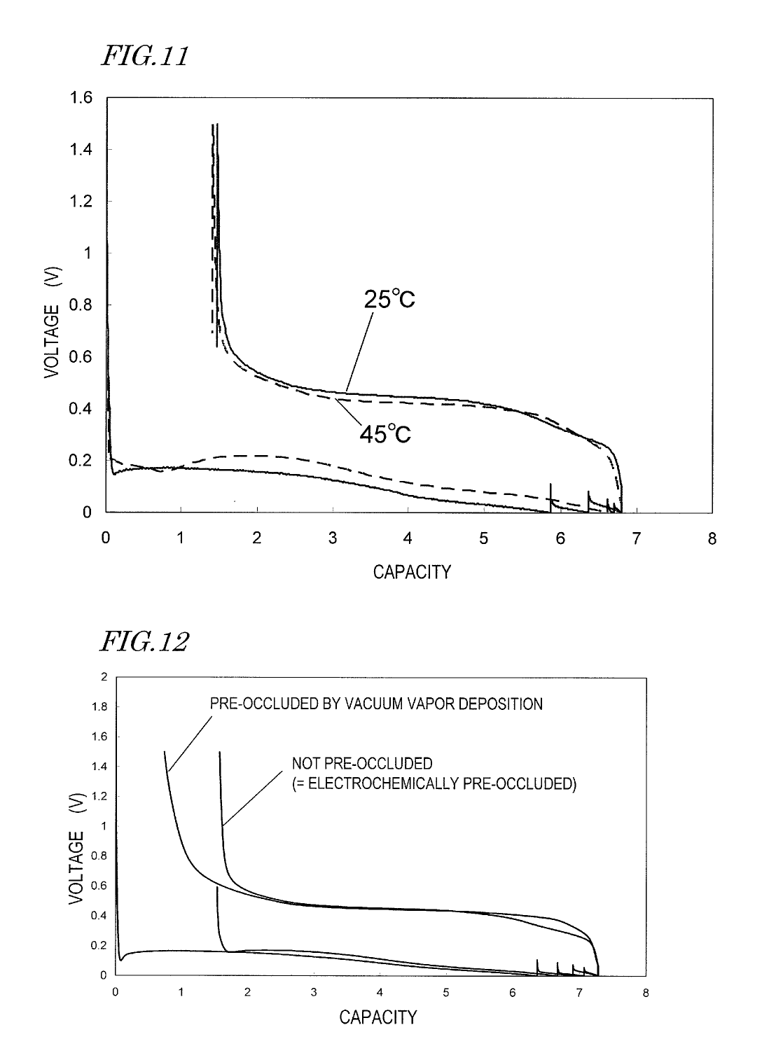

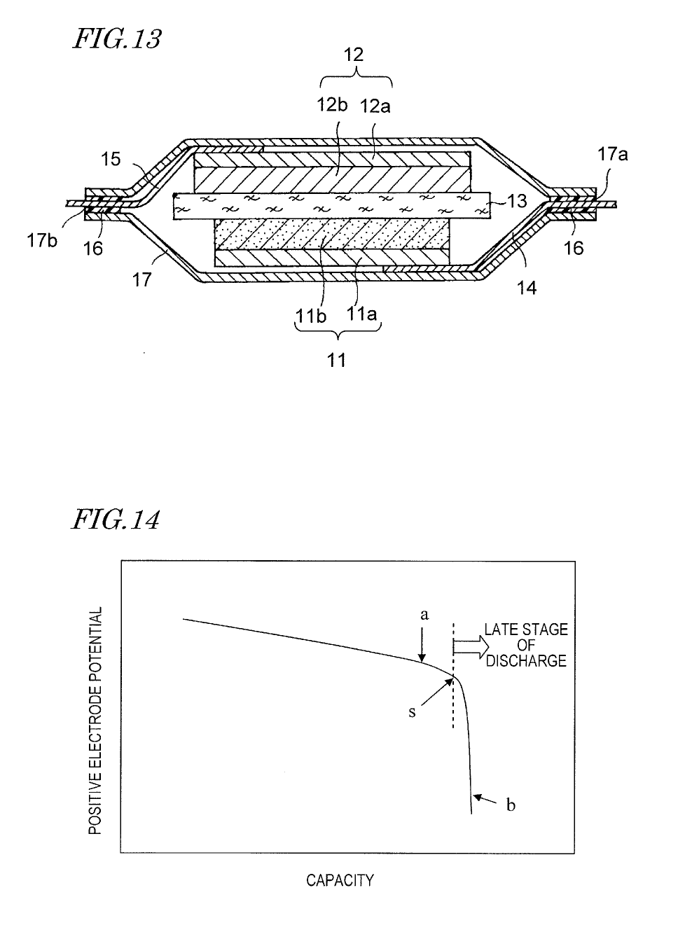

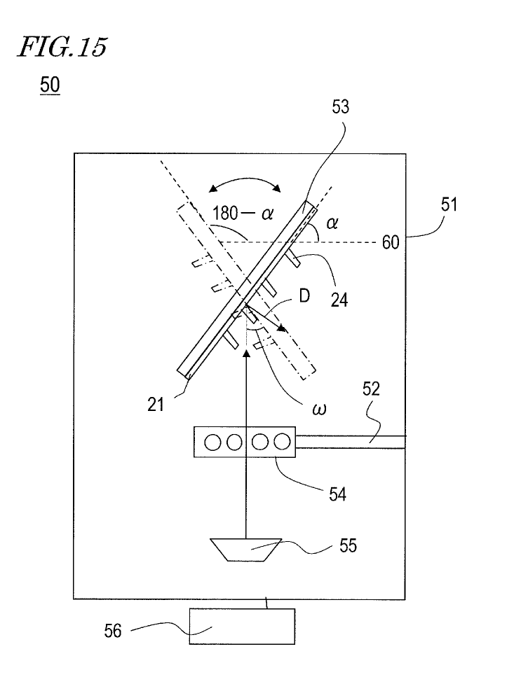

FIG. 12 shows an example of charge/discharge curves of a negative electrode having lithium pre-occluded thereto by the vacuum vapor deposition method and a negative electrode active material having pre-occluded thereto by the electrochemical technique. The charge/discharge curve of the negative electrode active material having pre-occluded thereto by the electrochemical technique is approximately the same as the charge/discharge curve of the negative electrode having no lithium pre-occluded thereto.

As can be seen from the graph shown in FIG. 12, when the vacuum vapor deposition method is used to have lithium be pre-occluded, the irreversible capacity of the negative electrode is decreased. A reason for this is that a part of lithium trapped inside the crystalline structure of the negative electrode is made movable and the irreversible capacity is decreased by the amount of this part of lithium. Owing to this, the positive electrode potential regulation can be kept more effectively.

Regardless of which of the above-described pre-occlusion methods is used, it is preferable that lithium is occluded in advance also to a part of the layer formed of the negative electrode active material (negative electrode active material layer) that does not face the positive electrode (non-facing part). In general, in order to prevent lithium from being deposited on the negative electrode, the area size of the negative electrode active material layer (negative electrode mixture area size) is larger than the area size of the positive electrode active material layer in the positive electrode (positive electrode mixture area size). Therefore, a part of the negative electrode active material layer is the non-facing part. When lithium is pre-occluded also to the non-facing part of the negative electrode active material layer, the average discharge potential of the entire negative electrode can be made lower than the potential of the part of the negative electrode that faces the positive electrode (facing part). Therefore, the positive electrode potential regulation can be maintained more effectively. For having lithium be pre-occluded in an amount larger than the irreversible capacity Qa of the negative electrode, it is preferable to set the excessive amount qa of lithium such that a sum of the excessive amount qa of lithium and the charge capacity of the positive electrode does not exceed the discharge capacity of the negative electrode. When the sum of the excessive amount qa of lithium and the charge capacity of the positive electrode exceeds the discharge capacity of the negative electrode, lithium may be undesirably deposited on the negative electrode.

<Relationship Between the Particle Properties and the Irreversible Capacity of the Positive Electrode>

The present inventor further found that the irreversible capacity of the positive electrode and the temperature dependence thereof are changed by the form or the particle properties of a nickel-based positive electrode active material.

In the case where a battery is used at room temperature, when the filling density of the positive electrode is increased or the diameter of a primary particle of the positive electrode active material is increased, the irreversible capacity of the positive electrode tends to be increased. Studies made by the present inventor found that the increasing ratio of the irreversible capacity of the positive electrode significantly depends on the environmental temperature. For example, when the environmental temperature is 45° C., a change in the particle properties of the positive electrode active material did not change the irreversible capacity almost at all, and the discharge capacity was approximately the same as the conventional discharge capacity. Therefore, in a battery using such a positive electrode active material, the increase in the capacity when the battery is used at a high temperature with respect to the capacity when the battery is used at room temperature is more conspicuous. Thus, the battery is preferably structured such that the capacity is maximized when the battery is used at a high temperature. In this case, when the battery is used at a high temperature, both of a large capacity and a high cycle characteristic can be provided.

A nickel-based positive electrode active material is formed of secondary particles, which is an aggregate of primary particles. A nickel-based positive electrode active material is produced as follows, for example.

First, a precursor of the positive electrode active material is produced by a coprecipitation method. Specifically, a pH of an aqueous solution containing a plurality of material salts dissolved therein is adjusted to precipitate a complex metal hydroxide which is uniform at an atomic level (precursor). Next, the precursor is dried and mixed with a lithium salt. Then, the mixture of the precursor and the lithium salt is based in a prescribed atmosphere at a prescribed temperature. Thus, the positive electrode active material is obtained. When the baking temperature is raised, the diameter of the primary particles is increased. A preferable baking temperature is 780 to 820° C. At such a baking temperature, a positive electrode active material having a primary particle diameter of about 0.2 to 1.5 μm is produced.

For increasing the capacity, it is preferable that the filling density of the positive electrode active material is higher. The filling density is preferably 3.0 to 4.0 g/cm³, and is more preferably 3.5 to 3.9 g/cm³. When the filling density is lower than 3.0 g/cm³, a sufficiently high volume capacity density is not obtained although the degree of destruction of the secondary particles is low. By contrast, when the filling density is higher than 4.0 g/cm³, the degree of destruction of the secondary particles is conspicuous and a sufficiently large void cannot be provided inside the positive electrode active material. As a result, the output characteristic is decreased.

One method for increasing the filling density is to applying a pressure by a roll press or the like. However, this method may destroy the primary particles forming the secondary particles due to the pressure. In order to reduce the destruction of the primary particles, it is preferable that the number of the primary particles forming the secondary particles is larger and the number of grain boundaries present in the secondary particles is smaller. Alternatively, the crystallinity may be increased to increase the strength of the secondary particles. The primary particle diameter (average diameter) is preferably 0.5 to 1.5 μm.

It has not been clarified in detail why the irreversible capacity of the positive electrode is increased when the filling density of the positive electrode active material is increased or the primary particle diameter is increased. The present invention presumes as follows.

When the secondary particles are destroyed, gaps are made among the primary particles. When the gaps become larger, the solid phase diffusion of lithium is inhibited among the primary particles. When the electrolyte solution permeates the gaps among the primary particles, the diffusion distance of lithium is made shorter. However, since an electron-conductive path is broken among the primary particles, the irreversible capacity is increased although not by the solid phase diffusion. In addition, a nickel-based oxide is sensitive to the air, and a surface thereof may be denatured when contacting the air. When a nickel-based oxide contacts the air during a production process thereof, Li ions in the crystalline structure of the oxide is partially replaced with protons. The post-replacement Li ions react with hydroxide ions or carbon dioxide to generate lithium hydroxide or lithium carbonate. When such products are formed on a surface layer of the primary particles, the solid phase diffusion of Li may be inhibited in substantially the same manner as described above. It is considered that as a result of this, the irreversible capacity of the positive electrode at room temperature is increased, and the difference between the irreversible capacity at room temperature and the irreversible capacity at 45° C. is increased.

A positive electrode active material in this embodiment is preferably a complex metal oxide of nickel and lithium. The nickel-based lithium-containing complex oxide may be an LiNiO₂-based material in which a part of Ni is substituted by another element selected from the group consisting of Mg, Sc, Y, Mn, Fe, Co, Ni, Cu, Zn, Al, Cr, Pb, Sb, and B. Among the nickel-based lithium-containing complex oxides, it is preferable to use LiₐNi_{1-(b+c)}Co_{b}M_{c}O₂ (where 1.0≦a≦1.05, 0.1≦b≦0.35, 0.005≦c≦0.30, and M is at least one selected from Al, Sr and Ca).

In order to suppress the polarization in a late stage of the discharge, which causes the irreversible capacity, in a LiNiO₂-based positive electrode active material, it is especially preferable to make Co and Al solid-solution (i.e., LiₐNi_{1-(b+c)}Co_{b}M_{c}O₂). In this case, an inter-a axis distance can be suppressed from being increased in a crystalline structure in a late stage of the discharge. When the inter-a axis distance is increased, inter-atom distance of Ni—Ni is increased and the electron density is decreased. This is considered to inhibit a smooth oxidation-reduction reaction.

LiNiO₂-based active materials generally have a problem that the crystalline structure is relatively largely changed by charge/discharge and thus a high reversibility is not provided. However, by adjusting the composition as described above, the reversibility can be improved while the capacity is kept high. A reason therefor will be described below.

When the value “a” is equal to or larger than 1.0, the amount of lithium salt used as a material is sufficient. Therefore, existence of electrochemically inactive impurities such as nickel oxide, cobalt oxide and the like is suppressed, and thus the decrease in the capacity is not easily induced. When the value “a” is equal to or smaller than 1.05, there is no excessive amount of lithium salt used as a material. Therefore, lithium compounds are suppressed from remaining as impurities and thus, again, the decrease in the capacity is not easily induced. The value “a” is a value when the battery is not charged.

When the value of b is equal to or larger 0.10, the charge/discharge reversibility can be improved with more certainty. When the value of b is equal to or smaller than 0.35, the decrease in the capacity does not easily occur. The value of c is preferably in the range of 0.005≦c≦0.30 in term of thermal stability. Especially preferably, the value of c is 0.01≦c≦0.10.

### Embodiment

Hereinafter, a structure of a lithium secondary battery in this embodiment according to the present invention will be described. A lithium secondary battery in this embodiment contains a lithium nickel complex oxide substantially having an irreversible capacity as a positive electrode active material. The particle properties and a preferable composition of the positive electrode active material are as described above. There is no specific limitation on the material of the negative electrode active material. For example, a carbon-based material such as graphite or the like, a silicon-based material such as SiOₓ or the like is usable as the negative electrode active material. The negative electrode active material contains lithium occluded thereto in advance. The amount of lithium occluded in advance is set such that in a completely discharged state of the lithium secondary battery when the environmental temperature is 25° C., the amount of lithium releasable from the negative electrode is larger than the irreversible capacity of the lithium secondary battery. The lithium secondary battery in this embodiment exhibits a charge/discharge behavior as shown in FIG. 7 when a carbon-based material is used as the negative electrode active material, and exhibits a charge/discharge behavior as shown in FIG. 10 when a silicon-based material is used as the negative electrode active material.

According to this embodiment, as described above, the time to finish the discharge can be regulated by the positive electrode potential at room temperature and also at a high temperature (e.g., 45° C.) (positive electrode potential regulation). Therefore, the increase in the reversible capacity provided by the improvement in the polarization in a late stage of the discharge of the positive electrode in a high temperature environment can be utilized to increase the capacity of the lithium secondary battery. Accordingly, the battery capacity can be increased without the charge/discharge cycle being decreased.

Each of the capacities of the lithium secondary battery in this embodiment is measured by the following method. The “amount of lithium releasable from the negative electrode” Qb is obtained by disassembling the post-discharge battery and measuring the negative electrode capacity of the battery. The “irreversible capacity of the negative electrode” Qa is obtained by measuring the amount of lithium in the negative electrode after the releasable amount of lithium is measured. The “irreversible capacity of the positive electrode” Qc may be calculated by measuring the amount of lithium of the pre-discharge positive electrode active material and the amount of lithium of the post-discharge positive electrode active material and finding the difference therebetween. The amount of lithium occluded to the negative electrode in advance (pre-occluded amount of lithium) may be calculated by the following expression by use of the capacities obtained by the above-described methods.

Pre-occluded amount of lithium=amount Qb of lithium releasable from the negative electrode−irreversible capacity Qc of the positive electrode+irreversible capacity Qa of the negative electrode

The increase in the positive electrode capacity is found by measuring a change in the positive electrode capacity caused by a temperature change.

FIG. 16 is a schematic cross-sectional view showing an example of lithium secondary battery in this embodiment.

The lithium secondary battery includes a battery case 1, an electrode group 4 accommodated in the battery case 1, and insulation rings 8 respectively disposed above and below the electrode group 4. The battery case 1 has an upper opening, which is sealed with a sealing plate 2.

The electrode group 4 has a structure in which a positive electrode 5 and a negative electrode 6 are wound a plurality of times in a spiral while having a separator 7 therebetween. A positive electrode lead 5a formed of, for example, aluminum is extended from the positive electrode 5, whereas a negative electrode lead 6a formed of, for example, copper is extended from the negative electrode 6. The positive electrode lead 5a is connected to the sealing plate 2 of the battery case 1. The negative electrode lead 6a is connected to a bottom part of the battery case 1. Although not shown, the battery case 1 accommodates an electrolyte solution injected thereinto together with the electrode group 4.

The lithium secondary battery having such a structure is produced as follows. First, the negative electrode 6 and the positive electrode 5 are formed, and are wound together with the separator 63 to form the electrode group 4. Next, insulation plates 8 are attached respectively above and below the electrode group 4. The positive electrode lead 5a extending from the positive electrode 4 is welded to a sealing plate 66, and the negative electrode lead 6a extending from the negative electrode 6 is welded to the bottom part of the battery case 1. These components are inserted into the battery case 1. Then, a nonaqueous electrolyte (not shown) for conducting lithium ions is injected into the battery case 1, and the opening of the battery case 1 is sealed with the sealing plate 2, with an insulation packing 3 being held between the battery case 1 and the sealing plate 2.

In this embodiment, the positive electrode 5 includes a positive electrode current collector and a positive electrode active material layer (positive electrode mixture layer) formed on a surface of the positive electrode current collector.

The positive electrode current collector may be, for example, a metal foil of aluminum or the like, a lathed or etched metal foil, or the like. As the material of the positive electrode current collector, any material which is routinely used in the field is usable. For example, a metal material such as stainless steel, titanium, aluminum or the like is usable. The positive electrode current collector has a thickness of, for example, equal to or larger than 10 μm. When the positive electrode current collector is too thick, the inner void volume of a battery case is small, and as a result, the energy density may be decreased. Therefore, the thickness of the positive electrode current collector is preferably equal to or smaller than 30 μm, and more preferably equal to or smaller than 20 μm.

The positive electrode mixture layer is formed on one surface or both surfaces of the positive electrode current collector by, for example, the following method. First, a positive electrode mixture paste is produced by causing a positive electrode active material, a binder, a conductive agent, and optionally a thickener to be kneaded and dispersed in a solvent. Next, the positive electrode mixture is applied to the surface of the positive electrode current collector and then dried to produce the positive electrode active material layer. There is no specific limitation on the method for rolling the current collector with the active material layer formed thereon. For example, the current collector may be rolled by a roll press machine a plurality of times with a line pressure of 1000 to 3000 kg/cm, until the active material layer attains a prescribed thickness. Alternatively, the current collector may be rolled a plurality of times with different line pressures. Still alternatively, in order to alleviate the inner stress of the mixture caused by the rolling, the current collector may be rolled while being optionally heated. In this manner, the filling density of the active material is made 3.0 to 4.0 g/cm³. Thus, the positive electrode is produced. The thickness of the positive electrode (total thickness of the positive electrode mixture layer and the current collector) is, for example, 100 μm to 200 μm. It is preferable that the positive electrode 5 is flexible.

In this embodiment, the positive electrode active material layer contains, as a positive electrode active material, a nickel-based lithium-containing complex oxide that is capable of occluding/releasing lithium. A preferable composition of the nickel-based lithium-containing complex oxide is the same as the composition described above.

On the binder to be used for the positive electrode mixture layer, there is no specific limitation. Any material which is stable against the solvent and the electrolyte solution to be used is usable. Usable materials include, for example, fluorine-based binders, acrylic rubber, modified acrylic rubber, styrene-butadiene rubber (SBR), isopropylene rubber, butadiene rubber, acrylic polymers, vinyl-based polymers, and the like. These materials may be used independently, or a mixture or a copolymer of two or more thereof may be used. Preferably usable fluorine-based binders include, for example, polyvinylidene difluoride (PVDF), a copolymer of vinylidene difluoride (VDF; registered trademark) and hexafluoropropylene (HFP) (P(VDF-HFP)), a dispersion of polytetrafluoroethylene resin, and the like. In order to increase the filling ratio of the active material so that the decrease in the void ratio of the mixture is suppressed, the bindability needs to be maintained by a small amount of binder. Preferably, 1 to 4 g of binder is used with respect to 100 g of active material.

Preferable usable thickeners include, for example, carboxymethyl cellulose, methyl cellulose, hydroxymethyl cellulose, ethyl cellulose, polyvinyl alcohol, oxidized starch, phosphated starch, casein, and the like.

Usable conductive agents include acetylene black, artificial graphite, natural graphite, carbon fiber, and the like. These materials may be used independently, or a mixture of two or more thereof may be used. In order to increase the filling ratio of the active material so that the decrease in the void ratio of the mixture is suppressed, the conductivity needs to be maintained by a small amount of conductive agent. Preferably, 0.5 to 3.0 g of conductive agent is mixed with 100 g of active material. It is preferable to mix carbon black such as acetylene black or the like and a graphite material such as artificial graphite.

On the solvent, there is no specific limitation. Any material in which the binder is dissolvable is usable. In the case where an organic-based binder is used, for example, an organic solvent such as N-methyl-2-pyrrolidone (NMP), N,N-dimethylformamide, tetrahydrofuran, dimethylacetamide, dimethylsulfoxide, hexamethyl sulfonamide, tetramethylurea, acetone, methyl ethyl ketone or the like is usable. These organic solvents may be used independently, or a mixed solvent containing two or more thereof may be used. In the case where an aqueous binder is used, it is preferable to use water or warm water as the solvent. For a nickel-based oxide which is weak against moisture, NMP having PVDF dissolved therein is preferable.

On the method for producing the positive electrode mixture paste, there is no specific limitation. For example, a planetary mixer, a homomixer, a pin mixer, a kneader, a homogenizer or the like may be used to knead and disperse a positive electrode or negative electrode active material, a binder, and an optionally-added conductive agent or conductive aid in a solvent. Such production methods may be used independently, or two or more thereof may be used in combination. When kneading and dispersing the materials in the solvent, various types of dispersants, surfactants, stabilizers and the like may be optionally added.

On the method for applying and drying the mixture (application and drying), there is no specific limitation. A mixture paste which is kneaded and dispersed in a solvent can be easily applied to the surface of the current collector by using, for example, a slit die coater, a reverse roll coater, a lip coater, a blade coater, a knife coater, a gravure coater, a dip coater, or the like. The applied mixture may be dried by a method which is close to natural drying. From the perspective of productivity, it is preferable to dry the mixture at a temperature of 70° C. to 200° C.

In this embodiment, the negative electrode 6 includes a negative electrode active material and a negative electrode active material layer formed on a surface of the negative electrode current collector. The negative electrode active material may be a graphite-based material such as artificial graphite, natural graphite or the like or an alloy material such as silicon, tin or the like.

A preferably usable graphite-based material has a reversible capacity of equal to or larger than 350 mAh/g and an irreversible capacity of equal to or smaller than 30 mAh/g. When such a graphite-based material is used, a larger reversible capacity can be provided at a charge/discharge potential close to a Li metal potential. It is especially preferable to use a highly crystalline graphite material having a lattice spacing (d002) of lattice planes (002) of 3.350 to 3.400 angstroms. The graphite material may be processed to be spherical, scaly or massive. In order to increase the filling density, graphite materials having different particle diameters may be mixed together.

On the alloy material used as the active material, there is no specific limitation. Any known material is usable. Usable materials include, for example, silicon-containing compounds, tin-containing compounds and the like. Usable silicon-containing compounds include, for example, silicon, oxides of silicon, nitrides of silicon, silicon-containing alloys, silicon compounds, solid solutions thereof, and the like. The oxides of silicon include, for example, silicon oxide represented by the composition SiOα (0<α<2). Carbides of silicon include, for example, silicon carbide represented by the composition SiCβ (0<β<1). The nitrides of silicon include, for example, silicon nitride represented by the composition SiNγ (0<γ<4/3). The silicon-containing alloys include, for example, an alloy containing silicon and one or a plurality of elements selected from the group consisting of Fe, Co, Sb, Bi, Pb, Ni, Cu, Zn, Ge, In, Sn and Ti. A part of silicon may be substituted with one or a plurality of elements selected from the group consisting of B, Mg, Ni, Ti, Mo, Co, Ca, Cr, Cu, Fe, Mn, Nb, Ta, V, W, Zn, C, N and Sn. Among these materials, SiOα (0<α<2) having a superb charge/discharge reversibility is especially preferable. The tin-containing compounds include, for example, tin, oxides of tin, nitrides of tin, tin-containing alloys, tin compounds, solid solutions thereof, and the like. Preferably usable tin-containing compounds include, for example, tin, oxides of tin such as SnOδ (O<δ<2), SnO₂ and the like, tin-containing alloys such as Ni—Sn alloy, Mg—Sn alloy, Fe—Sn alloy, Cu—Sn alloy, ti-Sn alloy and the like, and tin compounds such as SnSiO₃, Ni₂Sn₄, Mg₂Sn and the like. Among these materials, tin, and oxides of tin such as SnOβ (0<β<2), SnO₂ and the like are especially preferable.

For the negative electrode current collector, a rolled-out foil, an electrolytic foil or the like formed of, for example, copper or a copper alloy is usable. There is no specific limitation on the shape of the negative electrode current collector. Instead of a foil, a holed foil, an expanded material, a lathed material or the like is usable. A thicker negative electrode current collector, which provides a larger tensile strength, is preferable. However, when the negative electrode current collector is too thick, the inner void volume of the battery case is small, and as a result, the energy density may be decreased. For the purpose of improving the adhesiveness with the mixture, the foil may have projections, particles or the like formed on a surface thereof.

In the case where a powdery negative electrode active material is used, the negative electrode mixture layer is formed on one surface or both surfaces of the positive electrode current collector by, for example, the following method. First, the negative electrode mixture paste is produced by causing a negative electrode active material, a binder, a conductive agent, and optionally a thickener and an conductive aid to be kneaded and dispersed in a solvent. Next, the negative electrode mixture is applied to the surface of the negative electrode current collector and then dried to produce the negative electrode active material layer. Then, the negative electrode current collector with the negative electrode active material layer formed thereon is rolled. As a result, the negative electrode 6 is produced. It is preferable that the negative electrode 6 is flexible.

On the method for producing each of the positive electrode mixture paste and the negative electrode mixture paste, there is no specific limitation. For example, a planetary mixer, a homomixer, a pin mixer, a kneader, a homogenizer or the like may be used to knead and disperse a positive or negative electrode active material, a binder, and an optionally-added conductive agent or conductive aid in a solvent. Such production methods may be used independently, or two or more thereof may be used in combination. When kneading and dispersing the materials in the solvent, various types of dispersants, surfactants, stabilizers and the like may be optionally added.

On the method for applying and drying the mixture (application and drying), there is no specific limitation. A mixture paste which is kneaded and dispersed in a solvent can be easily applied to the surface of the current collector by using, for example, a slit die coater, a reverse roll coater, a lip coater, a blade coater, a knife coater, a gravure coater, a dip coater, or the like. The applied mixture may be dried by a method which is close to natural drying. From the perspective of productivity, it is preferable to dry the mixture at a temperature of 70° C. to 200° C.

On the method for rolling the current collector with the active material layer formed thereon, there is no specific limitation. For example, the current collector may be rolled by a roll press machine a plurality of times with a line pressure of 1000 to 3000 kg/cm, until the active material layer attains a prescribed thickness. Alternatively, the current collector may be rolled a plurality of times with different line pressures.

In the case where the mixture layer contains an alloy active material, the mixture layer may be directly deposited on the negative electrode current collector by a vapor deposition method such as a vacuum vapor deposition method, a sputtering method, a CVD method or the like.

As the separator 7, a microporous film or a nonwoven fabric of a polyolefin resin such as a polyethylene resin, a polypropylene resin or the like is usable. The microporous film or the nonwoven fabric may have a single layer or a multilayer structure. Preferably, the separator has a two layer structure including a polyethylene resin layer and a polypropylene resin layer, or a three layer structure including two polypropylene resin layers and a polyethylene resin layer interposed therebetween. It is preferable that such a separator has a shutdown function. The separator 7 preferably has a thickness of, for example, equal to or larger than 10 μm and equal to or smaller than 30 μm.

A nonaqueous electrolyte contains a nonaqueous solvent and an electrolyte. The nonaqueous solvent contains, for example, cyclic carbonate and chain carbonate as main components. Preferably, the cyclic carbonate is at least one selected from ethylene carbonate (EC), propylene carbonate (PC) and butylene carbonate (BC). Preferably, the chain carbonate is at least one selected from dimethyl carbonate (DMC), diethyl carbonate (DEC), ethyl methyl carbonate (EMC), and the like. The electrolyte contains, for example, a lithium salt which is strongly electron-withdrawing. Example of such a lithium salt include LiPF₆, LiBF₄, LiClO₄, LiAsF₆, LiCF₃SO₃, LiN(SO₂CF₃)₂, LiN(SO₂C₂F₅)₂, LiC(SO₂CF₃)₃ or the like. These electrolytes may be used independently, or two or more thereof may be used in combination. It is also preferable that such an electrolyte is dissolved in the nonaqueous solvent at a concentration of 0.5 to 1.5 M.

The nonaqueous electrolyte solution may contain a polymer material. For example, a polymer material which is capable of gelating a liquid substance is usable. Any polymer material which is routinely used in the field is usable. Usable polymer materials include, for example, polyvinylidene difluoride, polyacrylonitrile, polyethylene oxide and the like.

In the above embodiment, a nickel-based lithium-containing complex oxide (lithium nickel complex oxide) is used as a positive electrode active material. Alternatively, another lithium transition metal complex oxide, for example, a cobalt-based lithium-containing complex oxide, which is a complex metal oxide of cobalt and lithium (lithium cobalt complex oxide), may be used. As a cobalt-based lithium-containing complex oxide, LiₐCoO₂ (where 1.0≦a≦1.10) may be used. A part of Co may be substituted with another element for the purpose of improving the cycle characteristic or the thermal stability. A surface of the cobalt-based lithium-containing complex oxide may be covered with a metal oxide or the like.

As described above with reference to FIG. 7, a cobalt-based lithium-containing complex oxide exhibits a similar charge/discharge potential behavior to that of the nickel-base lithium-containing complex oxide shown in FIG. 2, and therefore substantially the same as describe above is provided. Namely, the increase in the reversible capacity of the positive electrode in a high temperature environment can be utilized to increase the capacity of the lithium secondary battery. Accordingly, the battery capacity can be increased without the charge/discharge cycle being decreased.

The positive electrode active material in this embodiment is not limited to a nickel-based lithium-containing complex oxide or a cobalt-based lithium-containing complex oxide, and may be another lithium transition metal complex oxide (e.g., a complex metal oxide of lithium and a transition metal such as manganese, chromium, iron, vanadium or the like).

### Examples and Comparative Examples

The present inventor produced lithium secondary batteries in examples and comparative examples and compared the battery capacities when these batteries are used at room temperature and at a high temperature. The method and results will be described, hereinafter.

(1) Production of Positive Electrode Active Materials A and B Used in Examples and Comparative Examples

In the examples and the comparative examples, two types of nickel-based lithium-containing complex oxides (LiNi_{0.815}Co_{0.15}Al_{0.035}O₂) having different average primary particle diameters (hereinafter, referred to as “positive electrode active materials A and B) were used.

(1-1) Positive Electrode Active Material A

First, an aqueous solution containing nickel sulfate at a concentration of 0.815 mol/L, an aqueous solution containing cobalt sulfate at a concentration of 0.15 mol/L, and an aqueous solution containing aluminum sulfate at a concentration of 0.035 mol/L were prepared and mixed. Next, the mixed aqueous solution was continuously supplied into a reaction vessel. Then, sodium hydroxide was dripped to the reaction vessel such that the aqueous solution in the reaction vessel would be maintained at a pH between 10 and 13, and thus a precursor of the active material was synthesized. The resultant precursor was washed well with water, and dried. In this manner, a hydroxide expressed by Ni_{0.815}Co_{0.15}Al_{0.035}(OH)₂ was obtained as the precursor.

The resultant precursor and lithium carbonate were mixed such that lithium, cobalt, nickel and aluminum would have a molar ratio (Ni:Co:Ni:Al) of 1:0.815:0.15:0.035. In an oxygen atmosphere, the mixture was prebaked at a temperature of 500° C. for 7 hours, and pulverized. Next, the pulverized bake was baked again at a temperature of 800° C. for 15 hours. The bake was pulverized and then subjected to a size classification. Thus, positive electrode active material A having a composition represented by LiNi_{0.815}Cu_{0.15}Al_{0.035}O₂ was obtained. The average primary particle diameter of positive electrode active material A was 0.5 μm.

(1-2) Positive Electrode Active Material B

Positive electrode active material B having a composition represented by LiNi_{0.815}Co_{0.15}Al_{0.035}O₂ was produced by substantially the same method except that the mixture of the precursor and lithium carbonate was baked at 800° C. The average primary particle diameter of positive electrode active material B was 1.0 μm.

(1-3) Positive Electrode Active Material C

An aqueous solution containing cobalt sulfate at a concentration of 0.98 mol/L and an aqueous solution containing magnesium sulfate at a concentration of 0.02 mol/L mixed. The mixed aqueous solution was continuously supplied into a reaction vessel. Then, sodium hydroxide was dripped to the reaction vessel such that the aqueous solution in the reaction vessel would be maintained at a pH between 10 and 13, and thus a precursor of the active material was synthesized. The resultant precursor was washed well with water, and dried. In this manner, a hydroxide expressed by Co_{0.98}Mg_{0.02}(OH)₂ was obtained as the precursor.

The resultant precursor and lithium carbonate were mixed such that lithium, cobalt and magnesium would have a molar ratio 1:0.98:0.02. The mixture was prebaked at a temperature of 600° C. for 10 hours, and pulverized. Next, the pulverized bake was baked again at a temperature of 900° C. for 10 hours. The bake was pulverized and then subjected to a size classification. Thus, positive electrode active material C having a composition represented by LiCo_{0.98}Mg_{0.02}O₂ was obtained. Positive electrode active material C was formed of only primary particles having an average particle diameter of 5 μm.

(2) Production of Positive Electrodes

Positive electrodes A-1 and A-2 were produced by use of positive electrode active material A, and positive electrode B-1 was produced by use of positive electrode active material B.

(2-1) Positive Electrode A-1

100 g of a powder of positive electrode active material A was mixed well with 1.2 g of acetylene black (conductive agent), 1.2 g of artificial graphite (conductive agent), 2 g of polyvinylidene difluoride (binder) and 50 ml of organic solvent (NMP) to prepare a mixture paste. This mixture paste was applied to one surface of an aluminum foil (positive electrode current collector) having a thickness of 15 μm. The mixture paste was dried to obtain a positive electrode active material layer.

Then, the aluminum foil having the positive electrode active material layer formed thereon was rolled to form positive electrode A-1. The thickness of the positive electrode, namely, the total thickness of the current collector and the positive electrode active material layer, was 65 μm, and the electrode capacity per unit area was 3.5 mAh/cm². This electrode capacity was a capacity in the case where lithium metal was used for the counter electrode and constant-current charge/discharge was conducted under conditions of charge current value: 0.1 mA/cm²; end voltage: 4.25 V; discharge current value: 0.1 mA/cm²; and end voltage: 3.0 V. The filling density of the obtained positive electrode A-1 was 3.55 g/cm³.

(2-2) Positive Electrode A-2

100 g of a powder of positive electrode active material A was mixed well with 1.2 g of acetylene black (conductive agent), 2 g of polyvinylidene difluoride (binder) and 50 ml of organic solvent (NMP) to prepare a mixture paste. This mixture paste was applied to one surface of an aluminum foil (positive electrode current collector) having a thickness of 15 μm. The mixture paste was dried to obtain a positive electrode active material layer.

Then, the aluminum foil having the positive electrode active material layer formed thereon was rolled to form positive electrode A-2. The thickness of the positive electrode was 60 μm, and the electrode capacity per unit area was 3.5 mAh/cm². The method for measuring the electrode capacity was the same as that described above in (2-1). The filling density of the obtained positive electrode A-2 was 3.85 g/cm³.

(2-3) Positive Electrode A-3

Positive electrode A-3 was produced by use of positive electrode active material A in substantially the same method as positive electrode A-1 except for the filling density. The filling density was 2.90 g/cm³. The thickness of the positive electrode, namely, the total thickness of the current collector and the positive electrode active material layer, was 77 μm, and the electrode capacity per unit area was 3.5 mAh/cm².

(2-4) Positive Electrode B-1

100 g of a powder of positive electrode active material B was mixed well with 1.2 g of acetylene black (conductive agent), 1.2 g of artificial graphite (conductive agent), 2 g of polyvinylidene difluoride (binder) and 50 ml of organic solvent (NMP) to prepare a mixture paste. This mixture paste was applied to one surface of an aluminum foil (positive electrode current collector) having a thickness of 15 μm. The mixture paste was dried to obtain a positive electrode active material layer.

Then, the aluminum foil having the positive electrode active material layer formed thereon was rolled to form positive electrode B-1. The thickness of the positive electrode was 65 μm, and the electrode capacity per unit area was 3.5 mAh/cm². The method for measuring the electrode capacity was the same as that described above in (2-1). The filling density of the obtained positive electrode B-1 was 3.55 g/cm³.

(2-5) Positive Electrode C-1

100 g of a powder of positive electrode active material C was mixed well with 2 g of acetylene black (conductive agent), 3 g of polyvinylidene difluoride (binder) and 50 ml of organic solvent (NMP) to prepare a mixture paste. This mixture paste was applied to one surface of an aluminum foil (positive electrode current collector) having a thickness of 15 μm. The mixture paste was dried to obtain a positive electrode active material layer.

Then, the aluminum foil having the positive electrode active material layer formed thereon was rolled to form positive electrode C-1. The thickness of the positive electrode, namely, the total thickness of the current collector and the positive electrode active material layer, was 58 μm, and the electrode capacity per unit area was 3.5 mAh/cm². This electrode capacity was a capacity in the case where lithium metal was used for the counter electrode and constant-current charge/discharge was conducted under conditions of charge current value: 0.1 mA/cm²; end voltage: 4.35 V; discharge current value: 0.1 mA/cm²; and end voltage: 3.0 V. The filling density of the obtained positive electrode C-1 was 3.70 g/cm³.

(3) Production of a Negative Electrode

As negative electrodes in examples and comparative examples, a graphite negative electrode using a graphite-based material as a negative electrode active material and a silicon negative electrode using a silicon-based material as negative electrode active material were produced.

(3-1) Graphite Negative Electrode

Artificial graphite and natural graphite were mixed such that the weight ratio would be 60:40 to produce a negative electrode active material. Next, 100 g of the negative electrode active material was mixed well with 0.6 g of a rubber-based binder (binder) and 1.0 g of carboxymethylcellulose (thickener) to prepare a mixture paste. This mixture paste was applied to one surface of a copper foil (negative electrode current collector) having a thickness of 8 μm. The mixture paste was dried to obtain a negative electrode active material layer.

Then, the copper foil having the negative electrode active material layer formed thereon was rolled to produce the graphite negative electrode having a thickness (total thickness of the current collector and the negative electrode active material layer) of 76 μm. The electrode capacity per unit area was 4.1 mAh/cm². This electrode capacity was a capacity in the case where lithium metal was used for the counter electrode and constant-current charge/discharge was conducted under conditions of charge current value: 0.1 mA/cm²; end voltage: 0 V; discharge current value: 0.1 mA/cm²; and end voltage: 1.5 V. The irreversible capacity of the obtained graphite negative electrode was 0.37 mAh/cm².

(3-2) Silicon Negative Electrode

First, a negative electrode current collector having concaved and convexed portions at a surface thereof was produced by a roller process method. Chromium oxide was thermal-sprayed to a surface of a cylindrical iron roller (diameter: 50 mm) to form a ceramic layer having a thickness of 100 μm. In a surface of the ceramic layer, a plurality of concaved portions having a depth of 6 μm were formed. Each concaved portion was a circle having a diameter of 12 μm as seen from above the ceramic layer. A bottom of each concaved portion was almost flat at a center thereof and rounded at a periphery thereof. The convexed portions were located in a most filled manner in which an inter-axis distance between adjacent convexed portions was 20 μm. Thus, the roller for forming convexed portions was obtained. Next, a copper alloy foil containing zirconia at a ratio of 0.03% by weight with respect to the entire amount thereof (trade name: HCL-02Z; thickness: 26 μm; produced by Hitachi Cable Ltd.) was annealed by being heated at a temperature of 600° C. for 30 minutes in an argon gas atmosphere. The resultant copper alloy foil was caused to pass a pressure-contact section, in which two rollers for forming convexed portions described above were pressure-contacted with each other, at a line pressure of 2 t/cm. As a result, both of two surfaces of the copper alloy foil was compression-molded. Thus, a negative electrode current collector having a plurality of convexed portions at both of the surfaces thereof was obtained. A cross-section of the negative electrode current collector vertical to the surfaces was observed by a scanning electron microscope. On both of the surfaces of the negative electrode current collector, a plurality of convexed portions having an average height of about 6 μm were formed. Then, copper particles were formed on a top surface of the convexed portions by electrolytic plating. The surface roughness was 2.0 μm.

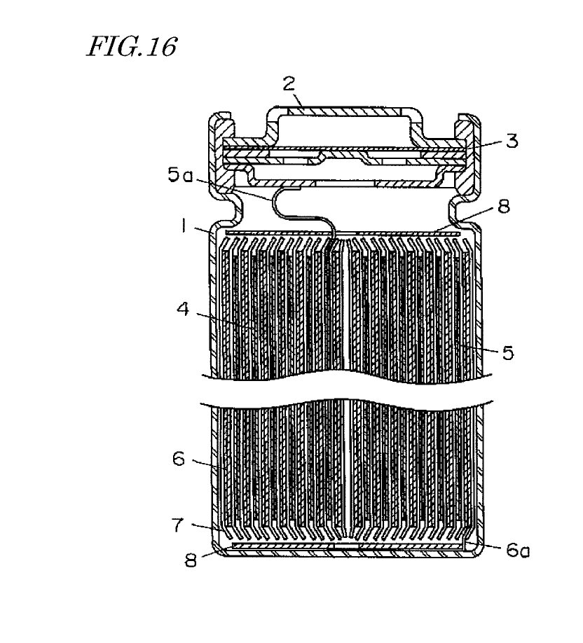

Next, on the surface of the negative electrode current collector obtained above, a negative electrode active material layer was formed by oblique vapor deposition. For forming the negative electrode active material layer, an electron beam vapor deposition device 50 shown in FIG. 15 was used.

The vapor deposition device 50 includes a vacuum chamber 51 and an exhaust pump 56 for exhausting the vacuum chamber 51. Inside the vacuum chamber 51, a fixing table 53 for fixing a current collector 21, a gas introduction pipe 52 for introducing gas into the chamber 51, and a melting pot 55 having a vaporization source for supplying silicon to a surface of the current collector 21 mounted thereon are installed. As the vaporization source, silicon, for example, is usable. Although not shown, electron beam heating means for vaporizing the material of the vaporization source is provided. The gas introduction pipe 52 includes an oxygen nozzle 54, and is located such that oxygen gas output from the oxygen nozzle 52 is supplied to the vicinity of the surface of the current collector 21. The fixing table 53 and the melting pot 55 are located such that vapor deposition particles (herein, silicon atoms) from the melting pot 55 are incident on the surface of the current collector 21 in a direction having an angle (vapor deposition angle) of w with respect to the normal direction D to the current collector 21. In this example, the fixing table 53 has a rotation shaft. By rotating the fixing table 53 about the rotation shaft, angle α of the fixing table 53 with respect to a horizontal plane 60 is adjusted to be equal to the prescribed vapor deposition angle ω. Herein, the “horizontal plane” refers to a plane vertical to a direction in which the material of the vapor deposition source mounted on the melting pot 55 is directed toward the fixing table 53 after being gasified.

Hereinafter, a method and conditions for forming a negative electrode active material layer by use of the vapor deposition device 50 will be described.

First, the negative electrode current collector (30 mm×30 mm) was fixed to the fixing table 53 of the vapor deposition device 50. The fixing table 53 was set to be located at a first position at which the angle thereof with respect to the horizontal plane would be 60° (α=60°) (represented by the solid line in FIG. 15) or at a second position at which the angle thereof with respect to the horizontal plane would be 120° (180−α=120°) (represented by the one-dot chain line in FIG. 15) in a switchable manner. Then, a vapor deposition step was performed 40 times while the position of the fixing table 53 was switched between the first position and the second position. During this process, the flow rate of oxygen was adjusted and the vacuum degree was controlled to form SiOₓ having different compositions. Specifically, in the first through seventh vapor deposition steps, the flow rate of oxygen was gradually decreased to gradually decrease the vacuum degree (vacuum degree in the first vapor deposition step: 3.5×10⁻² Pa→vacuum degree in the seventh vapor deposition step: 1.0×10⁻² Pa). In the eighth through 40th vapor deposition steps, the flow rate of oxygen was kept the same (vacuum degree: 5×10⁻² Pa).

Detailed vapor deposition conditions and materials were as follows.

Source material of the negative electrode active material (vapor deposition source): silicon; purity: 99.9999%; produced by Kojundo Chemical Lab. Co., Ltd.

Oxygen released from the oxygen nozzle 54: purity: 99.7%; produced by Nippon Sanso Kabushiki Kaisha

Output of electron beams: 5 kV

Vapor deposition time: 3 minutes×40 times

In this manner, the negative electrode active material layer including a plurality of active material bodies was formed on one surface of the negative electrode current collector. The active material bodies were respectively formed on the convexed portions of the negative electrode current collector, and each had a structure including 40 massive column-like bodies stacked sequentially. Each active material body was grown from an apex of the convexed portion and a part of a side surface in the vicinity of the apex, in a direction in which the convexed portion was extended. After this, oblique vapor deposition was performed on the other surface of the negative electrode current collector in substantially the same manner to form a negative electrode active material layer including a plurality of active material bodies. Thus, a silicon negative electrode active material including a negative electrode active material layer on each of two surfaces of the negative electrode current collector was obtained.

Next, the thickness of the negative electrode active material layer was found. Herein, a cross-section vertical to the negative electrode current collector in the obtained negative electrode was observed with a scanning electron microscope. Regarding each of 10 active material bodies formed on the surface of the convexed portions, a length from the apex of the convexed portion to an apex of the active material body was measured. An average of the resultant lengths was set as the “thickness of the negative electrode active material layer”. The thickness of the negative electrode active material layer was 14 μm.

The composition of the negative electrode active material layer was analyzed. In the vicinity of an interface between the negative electrode current collector (Cu) and the negative electrode active material layer (hereinafter, referred to simply as the “Cu—SiOₓ interface”), the oxidation degree x was as high as 1.0. In an area from the Cu—SiOₓ interface to a thickness of 3 μm, the oxidation degree x was gradually decreased. In an area from a thickness of 3μ from the Cu—SiOₓ interface to a thickness of to 14 μm from the Cu—SiOₓ interface, the oxidation degree x was 0.12. The average composition of the entirety of the negative electrode active material layer was SiO_{0.25} (average of the oxidation degree x: 0.25). The oxidation degree x indicates the molar ratio of amount of oxygen with respect to the amount of silicon in the oxide of silicon (SiOₓ).

The weight of silicon per unit area was 2.0 mg/cm². The electrode capacity per unit area was made 5.5 mAh/cm². This electrode capacity was a capacity obtained in a capacity evaluation in which where lithium metal was used for the counter electrode and constant-current charge/discharge was conducted under conditions of charge current value: 0.1 mA/cm²; end voltage: 0 V; discharge current value: 0.1 mA/cm²; and end voltage: 1.5 V. The irreversible capacity of the obtained silicon negative electrode was 1.0 mAh/cm².

(4) Pre-Occlusion of Lithium

The graphite negative electrode and the silicon negative electrode obtained in (3) above were caused to occlude lithium in advance in an electrochemical technique or a vacuum vapor deposition method to produce negative electrodes a-1, b-1, a-2 and b-2 in the following method.

(4-1) Electrochemical Technique

Negative Electrode a-1

An electrochemical cell containing the graphite negative electrode and lithium metal as a counter electrode was used. The graphite negative electrode was caused to occlude lithium in an amount corresponding to 0.5 mAh/cm², which was larger than the irreversible capacity of the graphite negative electrode. Then, the electrochemical cell was disassembled to take out the negative electrode having lithium occluded therein. The resultant negative electrode was washed with an organic solvent and then dried. This graphite negative electrode was labeled as negative electrode a-1.

Negative electrode b-1

The silicon negative electrode was caused to occlude lithium in an amount corresponding to 1.65 mAh/cm², which was larger than the irreversible capacity of the silicon negative electrode by substantially the same electrochemical technique as that used for negative electrode a-1. This silicon negative electrode was labeled as negative electrode b-1. The discharge capacity of negative electrode b-1 was approximately the same as the discharge capacity (5.5 mAh/cm²) before the lithium was pre-occluded (FIG. 12).

(4-2) Vacuum Vapor Deposition Method

Negative Electrode a-2

Lithium metal was vapor-deposited to the graphite negative electrode in an argon gas atmosphere by use of a resistive heating vapor deposition device (produced by ULVAC, Inc.).

First, lithium metal was put into a boat of tantalum in a chamber of the resistive heating vapor deposition device. Next, the graphite negative electrode was fixed such that one of negative electrode active material layers formed on one surface of the graphite negative electrode current collector would face the boat of tantalum. Then, in the argon atmosphere, a 50 A current was caused to flow through the boat of tantalum to vapor-deposit lithium metal. Thus, lithium metal in an amount corresponding to 0.5 mAh/cm² was vapor-deposited to the negative electrode active material layer of the graphite negative electrode. This graphite negative electrode was labeled as negative electrode a-2.

Negative Electrode b-2

Lithium metal was vapor-deposited to the silicon negative electrode by substantially the same method as that used for negative electrode a-2 (vacuum vapor deposition method). The silicon negative electrode was fixed in the chamber such that one of the negative electrode active material layers formed on both surfaces of the silicon negative electrode would face the boat of tantalum. Lithium in an amount corresponding to 1.6 mAh/cm² was vapor-deposited to one of the negative electrode active material layers of the silicon negative electrode. This silicon negative electrode was labeled as negative electrode b-2.

The discharge capacity of negative electrode b-2 was 6.1 mAh/cm², which was larger than the discharge capacity before lithium was pre-occluded. The discharge curve of the silicon negative electrode before and after the pre-occlusion of lithium was checked. It was found that as described above with reference to FIG. 12, the capacity was increased on the discharge side.

(4-3) Negative Electrode in the Comparative Example

In a comparative example, the graphite negative electrode or the silicon negative electrode described above was used without lithium being pre-occluded. The graphite negative electrode with no lithium being pre-occluded was labeled as negative electrode a, and the silicon negative electrode with no lithium being pre-occluded was labeled as negative electrode b.

Also as a comparative example, a negative electrode having lithium pre-occluded thereto by a transfer method was also produced. First, lithium metal in an amount corresponding to 1.6 mAh/cm² was vapor-deposited to a copper substrate. Next, the copper substrate having lithium metal vapor-deposited thereon and the silicon negative electrode were bonded together to obtain a precursor. In this step, the vapor-deposited and the vapor-deposited were bonded such that lithium metal vapor-deposited on the copper substrate and silicon in the silicon negative electrode would face each other. The obtained precursor was immersed in an electrolyte solution and kept still in an environment of 25° C. for 8 hours to have silicon occlude lithium. As the electrolyte solution, the same solution as that used in the charge/discharge test was used. After the occlusion, the copper substrate was separated from the silicon negative electrode. By this method, merely 15% of lithium first prepared (1.6 mAh/cm²) was occluded. The silicon negative electrode thus obtained was labeled as negative electrode b-3.

(5) Production of Lithium Secondary Batteries

As lithium secondary batteries in the examples and comparative examples, stacked-type cells described above with reference to FIG. 13 were produced,

Hereinafter, with reference to FIG. 13 again, a method for producing the lithium secondary battery in example 1 will be described. In example 1, positive electrode A-1 and negative electrode a-1 produced as above were used

First, positive electrode A-1 was cut into a size of 20 mm×20 mm to obtain the positive electrode 11. Negative electrode a-1 was cut into a size of 20.5 mm×20.5 mm to obtain the negative electrode 12. The positive electrode lead 14 and the negative electrode lead 15 were welded respectively to parts of the current collectors of the positive electrode 11 and the negative electrode 12 where the active material layers 11b and 12b were not formed. Then, the negative electrode 12, the separator 13, and the positive electrode 11 were stacked such that the positive electrode active material layer 11b of the positive electrode 11 and the negative electrode active material layer 12b of the negative electrode 12 would face each other while having the separator (herein, polyethylene microporous film) 13 therebetween to produce the electrode group. A part of the negative electrode active material layer 12b of the negative electrode 12 that does not face the positive electrode active material layer 11b (non-facing part) also had lithium occluded thereto in advance like the facing part.

The electrode group was inserted into the outer case 17, formed of an aluminum laminate, together with 0.2 g of electrolyte. The electrolyte was produced as follows: ethylene carbonate (EC), ethyl methyl carbonate (EMC) and diethyl carbonate (DEC) and vinylene carbonate were mixed at a volume ratio of 20:30:50:2, and LiPF₆ was dissolved in the resultant mixture solvent at a concentration of 1.0 mol/L.

Next, lithium metal was prepared for a reference electrode. The positive electrode lead 14, the negative electrode lead 15 and a reference electrode lead (not shown) were allowed to extend outside the outer case 17 through openings of the outer case 17. Then, the openings of the outer case 17 were welded while the inner pressure of the outer case 17 was vacuum-reduced. In this manner, the lithium secondary battery in example 1 was produced.

Lithium secondary batteries in examples 2 through 6 and comparative examples 1 through 3 were produced in substantially the same manner. The types of positive electrode and negative electrode used in the lithium secondary battery in each of examples and comparative examples are shown in Table 2. Table 3 shows the irreversible capacitance of the negative electrode and the battery, the amount of lithium occluded to the negative electrode in advance, and the amount of lithium releasable from the negative electrode in a completely discharged state at 25° C. in each of examples and comparative examples.

(6) Evaluation on the Battery Capacity and the Reversibility

First, the initial capacity of the lithium secondary battery in each of examples 1 through 6 and comparative examples 1 through 3 was found by the following evaluation conditions.

(Evaluation Conditions on the Initial Capacity)

Constant-current charge: 9 mA; end voltage: 4.2 V

Constant-voltage charge: end current: 0.7 mA; pause time: 20 minutes

Constant-current discharge: 2.8 mA; 2.5 V; pause time: 20 minutes

Test temperature: as shown in the table

When positive electrode C-1 was used, the end voltage of the constant-current charge was 4.3 V.

After the first cycle of the charge/discharge was performed under the above conditions, the discharge capacity per weight of the active material of the positive electrode after the first cycle of the charge/discharge was calculated and labeled as the “usable capacity (mAh/g) of the positive electrode active material”. The usable capacity is shown in Table 4. The usable capacity (initial capacity), the average discharge voltage and the volume of the electrode group in a charged state were used to calculate the volumetric energy density (Wh/L) of each lithium secondary battery. The ratio of the volumetric energy density with the volumetric energy density in comparative example 1 being 100, and is shown in Table 4.

Next, the second and subsequent cycles of the charge/discharge under the following conditions, and the reversibility of each lithium secondary battery was evaluated.

(Evaluation Conditions on the Charge/Discharge Reversibility)

Constant-current charge: 9 mA; end voltage: 4.2 V

Constant-voltage charge: end current: 0.7 mA; pause time: 20 minutes

Constant-current discharge: 14 mA; end voltage: 2.5 V; pause time: 20 minutes

Test temperature: 25° C.

When positive electrode C-1 was used, the end voltage of the constant-current charge was 4.3 V.

200 cycles of the charge/discharge were performed under the above conditions, and the capacity retention ratio (%) after the 200th cycle was found. The results are shown in Table 4.

TABLE 2

| | Type of positive electrode | | | | | |
|---|---|---|---|---|---|---|
| | | Average | | Type of negative electrode | | |
| | | particle | Filing | | | Lithium |
| | | diameter | density | | Active | occlusion |
| | | (μm) | (g/cm³) | | material | method |
| Example 1 | A-1 | 0.5 | 3.55 | a-1 | Graphite | Electrochemical |
| Example 2 | A-1 | 0.5 | 3.55 | a-2 | Graphite | Vacuum |
| | | | | | | vapor |
| | | | | | | deposition |
| Example 3 | A-1 | 0.5 | 3.55 | b-2 | SiOₓ | Vacuum |
| | | | | | | vapor |
| | | | | | | deposition |
| Example 4 | A-2 | 0.5 | 3.85 | b-2 | SiOₓ | Vacuum |
| | Filling | | | | | vapor |
| | density: high | | | | | deposition |
| Example 5 | A-3 | 0.5 | 2.90 | b-2 | SiOₓ | Vacuum |
| | Filling | | | | | vapor |
| | density: low | | | | | deposition |
| Example 6 | B-1 | 1.0 | 3.55 | b-2 | SiOₓ | Vacuum |
| | Average particle | | | | | vapor |
| | diameter: large | | | | | deposition |
| Example 7 | A-1 | 0.5 | 3.55 | b-1 | SiOₓ | Electrochemical |
| Example 8 | C-1 | 5 | 3.70 | b-2 | SiOₓ | Vacuum |
| | | | | | | vapor |
| | | | | | | deposition |
| Comparative | A-1 | 0.5 | 3.55 | a | Graphite | N/A |
| example 1 | | | | | | |
| Comparative | A-1 | 0.5 | 3.55 | b | SiOₓ | N/A |
| example 2 | | | | | | |
| Comparative | A-1 | 0.5 | 3.55 | b-3 | SiOₓ | Transfer |
| example 3 | | | | | | |

TABLE 3

| | | | | Releasable |
|---|---|---|---|---|
| | | | | amount of |
| | | | | lithium |
| | | | | releasable |
| | | | | from negative |
| | | | | electrode in a |
| | Negative | Pre- | | completely |
| | electrode | occluded | Battery | discharged |
| | irreversible | amount | irreversible | state of |
| | capacity | (mAh/ | capacity | battery at 25° C. |
| | (mAh/cm²) | cm²) | (mAh/cm²) | (mAh/cm²) |
| Example 1 | 0.37 | 0.50 | 0.40 | 0.53 |
| Example 2 | 0.37 | 0.50 | 0.40 | 0.53 |
| Example 3 | 1.54 | 1.60 | 0.40 | 1.04 |
| Example 4 | 1.54 | 1.60 | 0.41 | 1.05 |
| Example 5 | 1.54 | 1.60 | 0.40 | 1.04 |
| Example 6 | 1.54 | 1.60 | 0.42 | 1.06 |
| Example 7 | 1.54 | 1.60 | 0.40 | 0.50 |
| Example 8 | 1.54 | 1.60 | 0.15 | 0.79 |
| Comparative | 0.37 | — | 0.40 | 0.05 |
| example 1 | | | | |
| Comparative | 1.54 | — | −0.7 | 0 |
| example 2 | | | | |
| Comparative | 1.54 | 0.24 | −0.46 | 0 |
| example 3 | | | | |

TABLE 4

| | | | | Usable capacity of | | |
|---|---|---|---|---|---|---|
| | | | Energy | positive electrode | | Capacity retention |
| | Type of | Type of | density | active material | | ratio after |
| | positive | negative | ratio | (mAh/g) | | 200th |
| | electrode | electrode | 45° C. | 25° C. | 45° C. | cycle (%) |
| Example 1 | A-1 | a-1 | 105 | 190 | 202 | 85 |
| Example 2 | A-1 | a-2 | 105 | 190 | 202 | 86 |
| Example 3 | A-1 | b-2 | 123 | 190 | 202 | 83 |
| Example 4 | A-2 | b-2 | 123 | 188 | 202 | 83 |
| Example 5 | A-3 | b-2 | 122 | 190 | 200 | 83 |
| Example 6 | B-1 | b-2 | 122 | 186 | 202 | 83 |
| Example 7 | A-1 | b-1 | 118 | 190 | 195 | 78 |
| Example 8 | C-1 | b-2 | 122 | 164 | 169 | 86 |
| Comparative | A-1 | a | 100 | 190 | 191 | 84 |
| example 1 | | | | | | |
| Comparative | A-1 | b | 68 | 132 | 132 | 35 |
| example 2 | | | | | | |
| Comparative | A-1 | b-3 | 75 | 145 | 145 | 40 |
| example 3 | | | | | | |

The lithium secondary battery in comparative example 1 exhibited the potential behavior described above with reference to FIG. 5. Therefore, even when the environmental temperature was raised from 25° C. to 45° C., the increase in the usable capacity of the positive electrode active material was small. By contrast, the lithium secondary batteries in examples 1 and 2, having substantially the same structure as that of the lithium secondary battery in comparative example 1 except that the negative electrode was caused to occlude a prescribed amount of lithium in advance, exhibited the potential behavior described above with reference to FIG. 7. In each of examples 1 and 2, the usable capacity when the environmental temperature was 25° C. was the same as that in comparative example 1. When the environmental temperature raised to 45° C., the usable capacity was increased by 6% from the usable capacity at 25° C. It was also found that the lithium secondary batteries in examples 1 and 2 have a cycle characteristic as high as that of the lithium secondary battery in comparative example 1. Therefore, it was confirmed that in examples 1 and 2, the increase in the positive electrode capacity provided by the rise of the environmental temperature can be utilized to increase the battery capacity while the cycle characteristic is kept high.

The lithium secondary battery in comparative example 2 exhibited the potential behavior describe above with reference to FIG. 8. In comparative example 2, the irreversible capacity of the negative electrode (SiOₓ) was large, and thus the usable capacity of the positive electrode active material was small. This usable capacity was kept the same regardless of the environmental temperature. A reason for this is that the time to finish the discharge was regulated by the negative electrode potential and therefore the increase in the pose capacity is not reflected on the battery capacity at all. By contrast, the lithium secondary battery in example 3, having substantially the same structure as that of the lithium secondary battery in comparative example 1 except that the negative electrode was caused to occlude a prescribed amount of lithium in advance, exhibited the potential behavior described above with reference to FIG. 10. In example 3, the time to finish the discharge was regulated by the positive electrode potential, and therefore the usable capacity of the positive electrode active material was significantly increased. When the environmental temperature was raised (25° C. to 45° C.), the usable capacity was further increased by 6%. Therefore, it was confirmed that in example 3, pre-occlusion of lithium to the negative electrode increases the battery capacity, and also allows the increase in the positive electrode capacity provided by the rise in the environmental temperature to be utilized.

The lithium secondary battery in example 4 had substantially the same structure as that of the lithium secondary battery in example 3 except that the filling density was higher. The lithium secondary battery in example 4 exhibited substantially the same potential behavior as that of example 3. The increasing ratio of the usable capacity provided by the rise in the environmental temperature (25° C. to 45° C.) was higher than that in example 3 (6%). By contrast, when the filling density was decreased (example 5), the increasing ratio of the usable capacity was decreased. It was found from these results that the battery capacity at a high temperature can be increased more effectively by controlling the filling density of the positive electrode to the range of, for example, higher than 3.0 g/cm³ and lower than 4.0 g/cm.

The lithium secondary battery in example 6 had substantially the same structure as that of the lithium secondary battery in example 3 except that the primary particle diameter of the positive electrode was larger. The lithium secondary battery in example 6 exhibited substantially the same potential behavior as that of example 3. The increasing ratio of the usable capacity provided by the rise in the environmental temperature (25° C. to 45° C.) was higher than that in example 3 (6%). Therefore, it was found that the battery capacity at a high temperature can be increased more effectively by controlling the primary particle diameter.

In the lithium secondary battery in example 8 using a cobalt-based lithium-containing complex oxide as a positive electrode active material, a high charge/discharge cycle characteristic was obtained as in the other examples. It was found that the usable capacity can be increased by raising the environmental temperature. The increasing ratio of the usable capacity was about 3%.

In examples 3 through 7 using the silicon-based negative electrode having lithium be pre-occluded, a higher cycle characteristic was exhibited than in comparative example 2 using the silicon-based negative electrode with no lithium being pre-occluded. Reasons for this are as follows. In examples 3 through 7, the battery is of a positive electrode potential regulation type, and thus a potential area where the negative electrode rises in a late stage of the discharge is not used. By contrast, in comparative example 2, the battery is of a negative electrode potential regulation type, and thus a potential area where the negative electrode rises in a late stage of the discharge is used. When the negative electrode is used in this area, the negative electrode active material is contracted at the time of discharge and thus the particle destruction is promoted.

In comparative example 3, it was attempted to have lithium be occluded by a transfer method performed in a liquid phase. However, as described above, merely 15% of the prepared amount, and the pre-occluded amount was significantly smaller than the irreversible capacity of the negative electrode. A conceivable reason for this is that the post-processing copper substrate was separated from the silicon negative electrode, and therefore when lithium metal contacting silicon was occluded, physical contact was not kept, which resulted in a decrease the occluded amount.

The lithium secondary batteries in example 7 and example 3 are different from each other merely in the method for having the silicon-based negative electrode pre-occlude lithium. From a comparison of the evaluation results on these lithium secondary batteries, it was confirmed that the increasing ratio of the usable capacity provided by the rise in the environmental temperature is approximately the same and an effect of increasing the capacity at a high temperature is provided even when the method for having lithium be pre-occluded is different. When lithium was caused to be occluded by the vacuum vapor deposition method (example 3), the occlusion/release of lithium was smooth, and the polarization of the charge/discharge was smaller than when lithium was caused to occluded by the electrochemical technique (example 7). Thus, a higher cycle characteristic was obtained.

In examples 3 through 7 in which a nickel-based lithium-containing complex oxide was used as a positive electrode active material, the increasing ratio of the usable capacity provided by the rise in the environmental temperature was higher than in example 8 in which a cobalt-based lithium-containing complex oxide used. Therefore, it was found that the effect of increasing the usable capacity in this embodiment is provided more conspicuously when a nickel-based lithium-containing complex oxide is used as a positive electrode active material. A reason for this is that when a nickel-based lithium-containing complex oxide is used as a positive electrode active material, the temperature dependence of the diffusion of lithium in the positive electrode active material in a late stage of the discharge is high. Namely, at room temperature, the irreversible capacity is relatively increased; whereas at a high temperature, the increase amount in the capacity is increased.

### INDUSTRIAL APPLICABILITY

A lithium secondary battery according to the present invention is usable for substantially the same applications as a conventional lithium secondary battery, and is especially useful as a power supply of mobile electronic devices such as personal computers, mobile phones, mobile devices, personal digital assistants (PDAs), portable game machines, camcorders and the like. A lithium secondary battery according to the present invention is also expected to be usable as, for example, a secondary battery for assisting an electric motor of hybrid electric vehicles, fuel cell vehicles and the like; a driving power supply of electric tools, vacuum cleaners, robots and the like; and a power source of plug-in HEVs.

### REFERENCE SIGNS LIST

11 Positive electrode
11a Positive electrode current collector
11b Positive electrode active material
12 Negative electrode
12a Negative electrode current collector
12b Negative electrode active material
13 Separator
14 Positive electrode lead
15 Negative electrode lead
16 Gasket
17 Outer case
21 Negative electrode current collector
50 Electron beam vapor deposition device
51 Chamber
52 Gas introduction pipe
53 Fixing table
54 Oxygen nozzle
55 Melting pot
56 Exhaust pump

1-15. (canceled)

16. A lithium secondary battery, comprising:
a positive electrode containing a positive electrode active material capable of occluding/releasing lithium ions;
a negative electrode containing a negative electrode active material capable of occluding/releasing lithium ions;
a separator located between the positive electrode and the negative electrode; and
an electrolyte having a lithium ion conductivity;
wherein:
the positive electrode active material contains a lithium nickel complex oxide substantially having an irreversible capacity;
the negative electrode active material has lithium occluded thereto in advance by a vacuum vapor deposition method or an electrochemical technique;
in a completely discharged state of the lithium secondary battery when an environmental temperature is 25° C., an amount of lithium releasable from the negative electrode is larger than an irreversible capacity of the lithium secondary battery, and the completely discharged state is a state where the lithium secondary battery is discharged by a current of 0.2 C until having a battery voltage of 2.5 V;
the positive electrode active material of the positive electrode has a filling density of higher than 3.0 g/cm³ and lower than 4.0 g/cm³; and
the positive electrode active material form secondary particles, which are aggregates of primary particles, and the primary particles have an average particle diameter of equal to or larger than 0.5 μm.

17. The lithium secondary battery according to claim 16, wherein the lithium-nickel complex oxide has a composition represented by LiₐNi_{1-(b+c)}Co_{b}M_{c}O₂ (where 1.0≦a≦1.05, 0.1≦b≦0.35, 0.005≦c≦0.30, and M is at least one selected from Al, Sr and Ca).

18. The lithium secondary battery according to claim 16, wherein:
the negative electrode includes a negative electrode active material layer containing the negative electrode active material, and the positive electrode includes a positive electrode active material layer containing the positive electrode active material;
a part of the negative electrode active material layer faces the positive electrode active material layer while having the separator therebetween; and
the part of the negative electrode active material layer that faces the positive electrode active material layer and a part of the negative electrode active material layer that does not face the positive electrode active material layer have lithium occluded thereto in advance.

19. The lithium secondary battery according to claim 16, wherein the negative electrode active material contains silicon.

20. The lithium secondary battery according to claim 19, wherein the negative electrode active material has lithium occluded thereto in advance by the vacuum vapor deposition method.

21. The lithium secondary battery according to claim 16, wherein the negative electrode active material contains graphite.

22. A method for producing a lithium secondary battery, comprising:
(A) step of preparing a positive electrode including a lithium nickel complex oxide substantially having an irreversible capacity as a positive electrode active material capable of occluding/releasing lithium ions, and a negative electrode including a negative electrode active material capable of occluding/releasing lithium ions;
(B) step of having the negative electrode active material occlude lithium in advance by a vacuum vapor deposition method or an electrochemical technique; and
(C) step of locating the negative electrode after lithium is occluded to the negative electrode active material in advance and the positive electrode such that the negative electrode and the positive electrode have a separate therebetween, thereby forming an electrode group;
wherein:
an amount of lithium to be occluded in advance in step (B) is set such that in a completely discharged state of the lithium secondary battery when an environmental temperature is 25° C., an amount of lithium releasable from the negative electrode is larger than an irreversible capacity of the lithium secondary battery; and the completely discharged state is a state where the lithium secondary battery is discharged by a current of 0.2 C until having a battery voltage of 2.5 V;
the positive electrode active material of the positive electrode has a filling density of higher than 3.0 g/cm³ and lower than 4.0 g/cm³; and
the positive electrode active material form secondary particles, which are aggregates of primary particles, and the primary particles have an average particle diameter of equal to or larger than 0.5 μm.

23. The method for producing a lithium secondary battery according to claim 22, wherein the negative electrode active material contains silicon, and in step (B), the lithium is occluded to the negative electrode active material in advanced by the vacuum vapor deposition method.

24. A lithium secondary battery, comprising:
a positive electrode containing a positive electrode active material capable of occluding/releasing lithium ions;
a negative electrode containing a negative electrode active material capable of occluding/releasing lithium ions;
a separator located between the positive electrode and the negative electrode; and
an electrolyte having a lithium ion conductivity;
wherein:
the positive electrode active material contains a lithium transition metal complex oxide having an irreversible capacity;
the negative electrode active material has lithium occluded thereto by a vacuum vapor deposition method or an electrochemical technique;
in a completely discharged state of the lithium secondary battery when an environmental temperature is 25° C.,
an amount of lithium releasable from the negative electrode is larger than a capacity increase of the positive electrode at a temperature higher than the environmental temperature and is larger than an irreversible capacity of the positive electrode at the environmental temperature,
a pre-occluded amount of lithium of the negative electrode active material is larger than the irreversible capacity of the negative electrode; and
a difference between the pre-occluded amount of lithium of the negative electrode active material and the irreversible capacity of the negative electrode is equal to a difference between the amount of lithium releasable from the negative electrode and the irreversible capacity of the positive electrode;
the completely discharged state is a state where the lithium secondary battery is discharged by a current of 0.2 C until having a battery voltage of 2.5 V;
the positive electrode active material of the positive electrode has a filling density of higher than 3.0 g/cm³ and lower than 4.0 g/cm³; and
the positive electrode active material form secondary particles, which are aggregates of primary particles, and the primary particles have an average particle diameter of equal to or larger than 0.5 μm.

25. The lithium secondary battery according to claim 24, wherein the lithium transition metal complex oxide is a lithium nickel complex oxide.

26. The lithium secondary battery according to claim 24, wherein the lithium transition metal complex oxide is a lithium cobalt complex oxide.
